(19) United States
(12) Patent Application Publication
(10) Pub. No.: US 2024/0235638 A1
(43) Pub. Date: Jul. 11, 2024

(54) UE-INITIATED REPORTING

(71) Applicant: Samsung Electronics Co., Ltd., Suwon-si (KR)

(72) Inventors: Gilwon Lee, McKinney, TX (US); Md. Saifur Rahman, Plano, TX (US); Dalin Zhu, Allen, TX (US); Emad Nader Farag, Flanders, NJ (US); Eko Onggosanusi, Coppell, TX (US)

(21) Appl. No.: 18/402,539

(22) Filed: Jan. 2, 2024

Related U.S. Application Data
(60) Provisional application No. 63/438,414, filed on Jan. 11, 2023.

(51) Int. Cl. H04B 7/06; H04L 1/1607; H04W 72/21

(52) U.S. Cl. CPC H04B 7/0626; H04L 1/1614; H04W 72/21

(57) ABSTRACT

Apparatuses and methods for UE-initiated reporting. A method performed by a user equipment (UE) includes receiving information about (i) L events and (ii) K event types, where L≥1 and K≥1. At least one of the L events is associated with at least one of the K event types. The method further includes determining whether to transmit a report based on at least one of L′ events from the L events and transmitting, based on the determination, the report that includes an indicator indicating the L′ events.

### CROSS-REFERENCE TO RELATED APPLICATION AND CLAIM OF PRIORITY

This application claims priority under 35 U.S.C. § 119(e) to U.S. Provisional Patent Application No. 63/438,414 filed on Jan. 11, 2023, the contents of which is hereby incorporated by reference in its entirety.

### TECHNICAL FIELD

The present disclosure relates generally to wireless communication systems and, more specifically, to electronic devices and methods for UE-initiated reporting.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for UE-initiated reporting.

In one embodiment, a user equipment (UE) is provided. The UE includes a transceiver configured to receive information about (i) L events and (ii) K event types, where L≥1 and K≥1. At least one of the L events is associated with at least one of the K event types. The UE further includes a processor operably coupled to the transceiver. The processor is configured to determine whether to transmit a report based on at least one of L′ events from the L events. The transceiver is further configured to transmit, based on the determination, the report that includes an indicator indicating the L′ events.

In another embodiment, a base station (BS) is provided. The BS includes a processor and a transceiver operably coupled to the processor. The transceiver is configured to transmit information about (i) L events and (ii) K event types, where L≥1 and K≥1, and receive a report that includes an indicator indicating at least one of L′ events from the L events. At least one of the L events is associated with at least one of the K event types.

In yet another embodiment, a method performed by a UE is provided. The method includes receiving information about (i) L events and (ii) K event types, where L≥1 and K≥1. At least one of the L events is associated with at least one of the K event types. The method further includes determining whether to transmit a report based on at least one of L′ events from the L events and transmitting, based on the determination, the report that includes an indicator indicating the L′ events.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4 and 5 illustrate example wireless transmit and receive paths according to embodiments of the present disclosure;

FIG. 6A illustrates an example of a beam having a beam width and a beam direction according to embodiments of the present disclosure;

FIG. 6B illustrates an example of multi-beam operation according to embodiments of the present disclosure;

FIG. 7 illustrates an example antenna blocks or arrays forming beams according to embodiments of the present disclosure;

FIG. 8 illustrates an example of a configuration for UE-initiated/UE-triggered reporting being associated with a single event according to embodiments of the present disclosure;

FIG. 9 illustrates an example of a configuration for UE-initiated/UE-triggered reporting being associated with multiple events according to embodiments of the present disclosure;

FIG. 10 illustrates an example of a configuration for UE-initiated/UE-triggered reporting being associated with a single event-type according to embodiments of the present disclosure;

FIG. 11 illustrates an example of a configuration for UE-initiated/UE-triggered reporting being associated with multiple event types according to embodiments of the present disclosure;

FIG. 12 illustrates a configuration for UE-initiated/UE-triggered reporting being associated with a single event-type and an event, where the single event-type is linked to or associated with the event according to embodiments of the present disclosure;

FIG. 13 illustrates a configuration for UE-initiated/UE-triggered reporting being associated with a single event-type and multiple events, where the single event-type is linked to or associated with the multiple events according to embodiments of the present disclosure;

FIG. 14 illustrates an example of a configuration for UE-initiated/UE-triggered reporting being associated with multiple event types and a single event, wherein the multiple event types are associated with the single event according to embodiments of the present disclosure;

FIG. 15 illustrates a configuration for UE-initiated/UE-triggered reporting being associated with multiple event types and multiple events, wherein each event type is associated with each event according to embodiments of the present disclosure;

FIG. 16 illustrates a configuration for UE-initiated/UE-triggered reporting being associated with multiple event types and multiple events, wherein each event type is associated with multiple events according to embodiments of the present disclosure;

FIG. 17 illustrates a configuration for UE-initiated/UE-triggered reporting being associated with multiple event types and multiple events, wherein each event is associated with multiple event types according to embodiments of the present disclosure;

FIG. 18 illustrates a configuration for UE-initiated/UE-triggered reporting being associated with multiple event types and multiple events for each group, wherein multiple event types are associated with multiple events for each group according to embodiments of the present disclosure;

FIG. 19 illustrates an example of CSI-ReportConfig including an enabling parameter for UE-initiated/triggered reporting according to embodiments of the present disclosure;

FIG. 20 illustrates an example of CSI-ReportConfig including parameters/indicators for UE-initiated/triggered reporting according to embodiments of the present disclosure;

FIG. 21 illustrates an example of CSI-ReportConfig including parameters/indicators for UE-initiated/triggered reporting according to embodiments of the present disclosure;

FIG. 22 illustrates an example of CSI-ReportConfig including parameters/indicators for UE-initiated/triggered reporting according to embodiments of the present disclosure;

FIG. 23 illustrates an example of Framework 2, where a new IE(s) is defined for parameters/indicators for UE-initiated/triggered reporting and an ID(s) of the new IE is included in CSI-ReportConfig according to embodiments of the present disclosure;

FIG. 24 illustrates an example of Framework 3 according to embodiments of the present disclosure;

FIG. 25 illustrates an example of Framework 4 that includes a new report configuration according to embodiments of the present disclosure;

FIG. 26 illustrates another example of Framework 4 that includes a new report configuration according to embodiments of the present disclosure;

FIG. 27 illustrates an example of UE-initiated/UE-triggered reporting according to embodiments of the present disclosure;

FIG. 28 illustrates a flow diagram of an example two-stage UCI framework for UE-initiated/UE-triggered reporting according to embodiments of the present disclosure; and

FIG. 29 illustrates a flow diagram of another example two-stage UCI framework for UE-initiated/UE-triggered reporting according to embodiments of the present disclosure.

### DETAILED DESCRIPTION

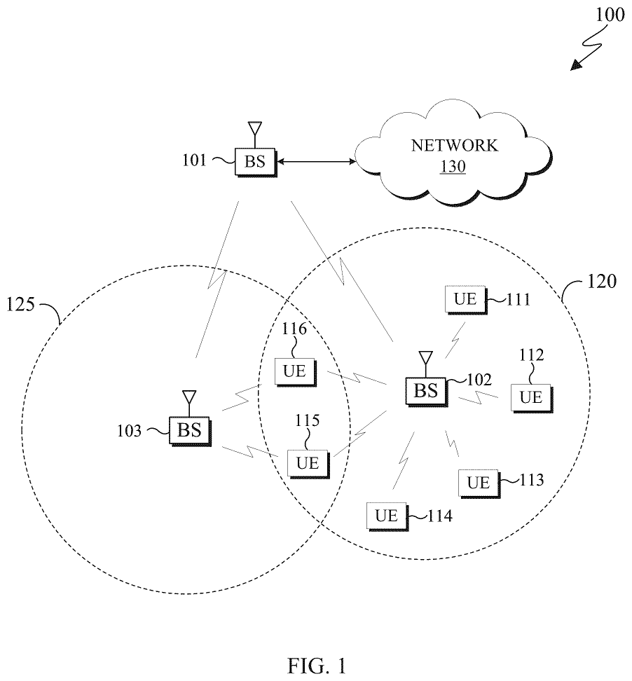

FIGS. 1 through 29, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 38.211 v17.2.0, “NR; Physical channels and modulation;” 3GPP TS 38.212 v17.2.0, “NR; Multiplexing and Channel coding;” 3GPP TS 38.213 v17.2.0, “NR; Physical Layer Procedures for Control;” 3GPP TS 38.214 v17.2.0, “NR; Physical Layer Procedures for Data;” 3GPP TS 38.321 v17.1.0, “NR; Medium Access Control (MAC) protocol specification;” 3GPP TS 38.331 v17.1.0, “NR; Radio Resource Control (RRC) Protocol Specification.”

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for UE-initiated reporting. In certain embodiments, one or more of the BSs 101-103 include circuitry, programing, or a combination thereof for supporting UE-initiated reporting.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

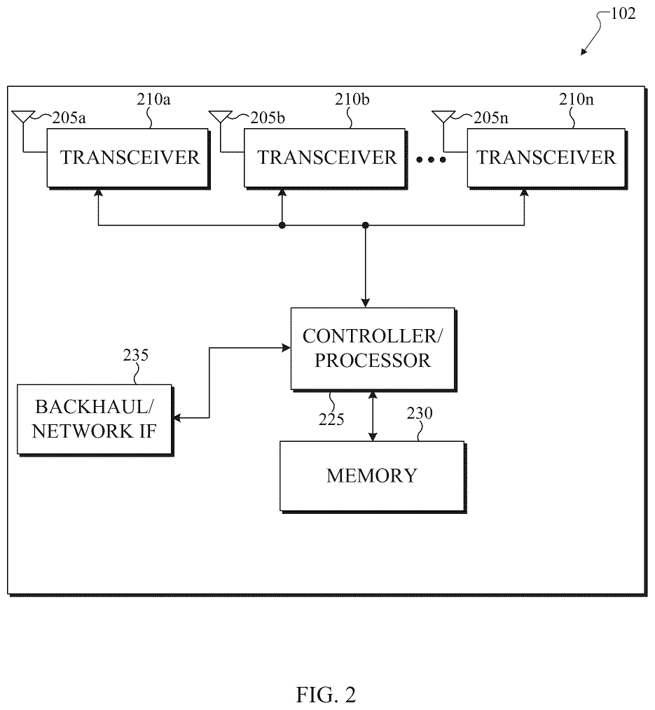

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting UE-initiated reporting. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

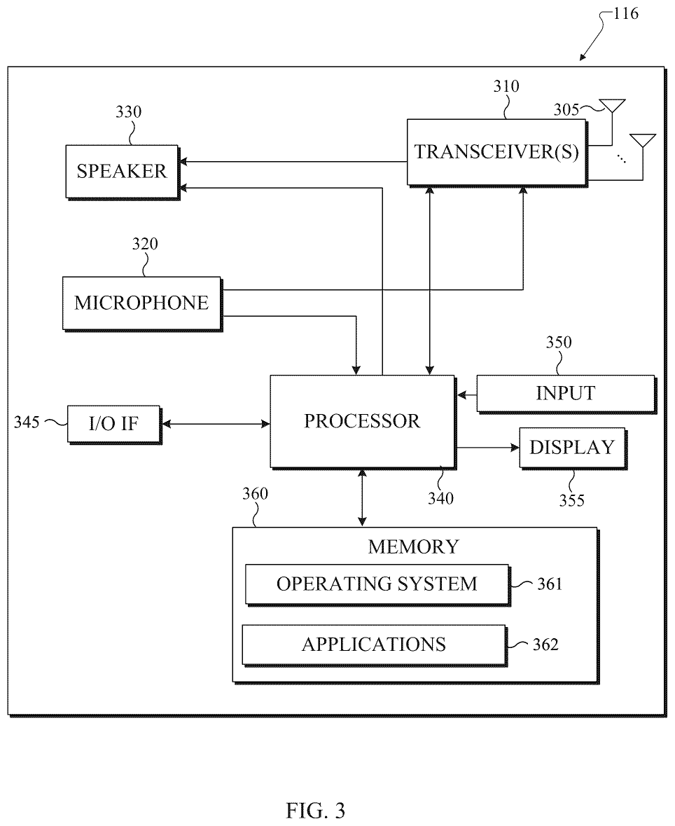

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. As another example, the processor 340 could support methods for UE-initiated reporting. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

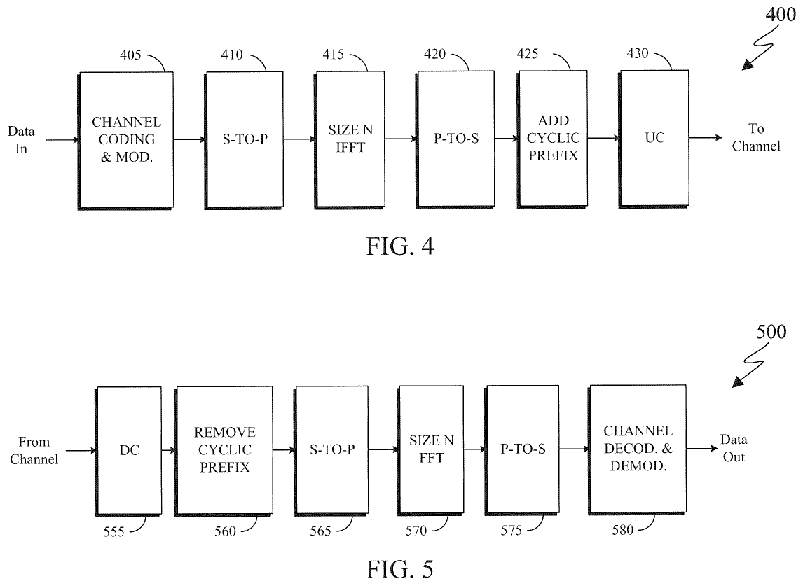

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to support UE-initiated reporting as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In the present disclosure, a beam is determined by either of;
A TCI state, which establishes a quasi-colocation (QCL) relationship between a source reference signal (e.g., SSB and/or CSI-RS) and a target reference signal
A spatial relation information that establishes an association to a source reference signal, such as SSB or CSI-RS or SRS.
   In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

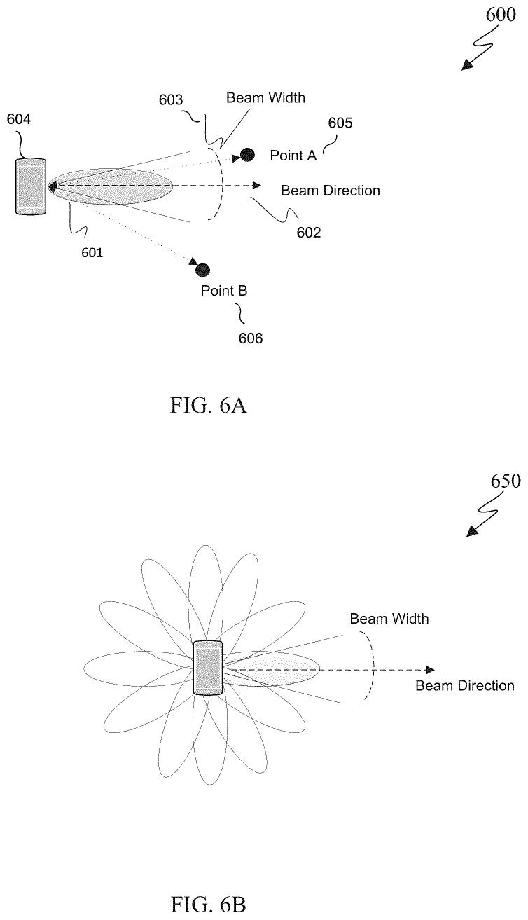

FIG. 6A illustrates an example of a beam having a beam width and a beam direction 600 according to embodiments of the present disclosure. The embodiment of the beam having a beam width and a beam direction 600 shown in FIG. 6A is for illustration only. Other embodiments of the beam having a beam width and a beam direction 600 could be used without departing from the scope of this disclosure.

FIG. 6B illustrates an example of multi-beam operation 650 according to embodiments of the present disclosure. The embodiment of the multi-beam operation 650 shown in FIG. 6B is for illustration only. Other embodiments of the multi-beam operation 650 could be used without departing from the scope of this disclosure.

As illustrated in FIG. 6A, in a wireless system a beam 601, for a device 604, can be characterized by a beam direction 602 and a beam width 603. For example, the device 604 transmits radio frequency (RF) energy in a beam direction and within a beam width. The device 604 receives RF energy in a beam direction and within a beam width. As illustrated in FIG. 6A, a device at point A 605 can receive from and transmit to the device 604 as Point A is within a beam width and direction of a beam from the device 604. As illustrated in FIG. 6A, a device at point B 606 cannot receive from and transmit to the device 604 as Point B is outside a beam width and direction of a beam from the device 604. While FIG. 6A, for illustrative purposes, shows a beam in 2-dimensions (2D), it should be apparent to those skilled in the art, that a beam can be in 3-dimensions (3D), where the beam direction and beam width are defined in space.

In a wireless system, a device can transmit and/or receive on multiple beams. This is known as “multi-beam operation” and is illustrated in FIG. 6B. For illustrative purposes, the beam in FIG. 6B is shown in 2D. However, it should be apparent to those skilled in the art, that a beam can be 3D, where a beam can be transmitted to or received from any direction in space.

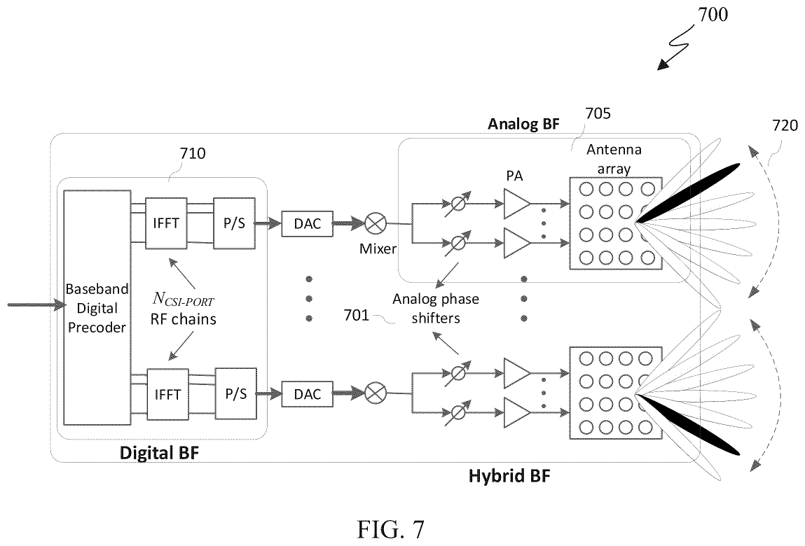

FIG. 7 illustrates an example antenna blocks or arrays 700 according to embodiments of the present disclosure. The embodiment of the antenna blocks or arrays 700 illustrated in FIG. 7 is for illustration only. FIG. 7 does not limit the scope of this disclosure to any particular implementation of the antenna blocks or arrays.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7. In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports NCSI-PORT. A digital beamforming unit 710 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

Embodiments of the present disclosure recognize that in the NR specification, the most resource-efficient reporting mechanism for a content (e.g., beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g., beam, CSI etc.). For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB. Such UE-initiated reporting for a content can be enabled for other types of report quantities (different from traditional beam or CSI reports).

Embodiments of the present disclosure recognize that although UE-initiated reporting can be beneficial, efficient designs are needed to ensure that the latency is reduced and, at the same time, error events can be minimized. Therefore, there is a need for efficient designs for UE-initiated reporting for a content that can offer good trade-off between latency and reliability. In particular, when the UE-initiated reporting framework can include multiple report types (or report quantities), and/or multiple event types when a report types can be associated with an event (e.g., for beam report, the event can be beam failure, and for CSI, the event can be user throughput degradation or increasing retransmission rate).

Accordingly, embodiments of the present disclosure provide mechanisms for facilitating UE-initiated reporting. More specifically, embodiments of the present disclosure provide a framework on reporting, event, and/or event-type association and a framework for two-stage UCI UE-initiated reporting.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The report is to facilitate/enable efficient/timely/fast/reliable communication over the link/channel between a target entity (e.g., NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is a beam (source RS) indicator (e.g., CRI, SSBRI) and Jᵢ is a beam metric (e.g., L1-RSRP, L1-SINR).
In one example, the content includes CSI-related quantity/quantities. For example, at least one of (RI, PMI, CQI, CRI, LI).
In one example, the content includes TDCP-related quantity/quantities. For example, an indicator about the Doppler profile (e.g., Doppler spread or Doppler shift, relative Doppler spreads, or relative Doppler shifts), or an indicator about the auto-correlation profiles (e.g., (auto-)correlation values corresponding to a few dominant lags/delays).
In one example, the content includes other (e.g., non-beam, non-CSI, non-TDCP) quantity/quantities.
   In one example, quantity/quantities comprises a selector/indicator indicating selection of one (or >1) of either:
      beam (TCI state) TCI states (e.g., DL TCI state, UL TCI state, or unified (joint) DL/UL TCI state), or
      panel(s) (e.g., UE panels for DL reception and/or UL transmission), or
      antenna(e) (e.g., UE antennae for DL reception and/or UL transmission), or
      antenna port(s) (e.g., UE antenna ports for DL reception and/or UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g., this switching is for DL reception and/or UL transmission).
In one example, the content includes beam-related quantity/quantities (examples above) and at least one other quantity/quantities (examples above).
In one example, the content includes CSI-related quantity/quantities (examples above) and at least one other quantity/quantities (examples above).
In one example, the content includes TDCP-related quantity/quantities (examples above) and at least one other quantity/quantities (examples above).
In one example, the content includes beam-related quantity/quantities (examples above) and CSI-related quantity/quantities (examples above).
In one example, the content includes beam-related quantity/quantities (examples above) and TDCP-related quantity/quantities (examples above).
In one example, the content includes TDCP-related quantity/quantities (examples above) and CSI-related quantity/quantities (examples above).

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the UE is a Uu interface (i.e., DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e., without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| Event | | Trigger/pre- | |
| type | Type | notification message | Content |
| 0: beam | (A) | Yes (e.g., beam-related event) | No |
| | (B) | No | Yes |
| | (C) | Yes (e.g., beam-related event) | Yes |
| 1: CSI | (A) | Yes (e.g., CSI-related event) | No |
| | (B) | No | Yes |
| | (C) | Yes (e.g., CSI-related event) | Yes |
| 2: TDCP | (A) | Yes (e.g., TDCP-related event) | No |
| | (B) | No | Yes |
| | (C) | Yes (e.g., TDCP-related event) | Yes |
| 3: non- | (A) | Yes (e.g., non-CSI-related event) | No |
| CSI/beam/TDCP | (B) | No | Yes |
| | (C) | Yes (e.g., non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g., beam-related event), | No |
| | content-specific or event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, an index or a parameter (e.g., reportQuantity) can be used to indicate one example from above tables. The index/parameter can be used to configure the UE-initiated report according to one of the above examples, e.g., via higher layer RRC. Such a configuration can be subject to the UE capability. In one example, the index/parameter can also indicate multiple (e.g., 2) examples from above table. In this case, the UE-initiated report can include the report for at least one for the two.

In one embodiment, for an event-based UE-initiated report, an event can be according to at least one of the following examples.
In one example, for a beam-related event-type, at least one of the examples can be used as an event.
   In one example, the event is related to transmission/decoding failure or BLER, e.g., the UE initiates/triggers a beam report when the event is detected, implying the transmission/decoding failure may happen (or BLER may exceed a threshold) with the current beam.
   In one example, the event is related to beam failure, e.g., the UE initiates/triggers a beam report when the event is detected, implying the beam failure may happen with the current beam.
   In one example, the event is related to maximum permissible emission (MPE), the UE initiates/triggers a beam report when the MPE is detected, implying the Tx power can exceed the MPE limit/threshold with the current beam.
   In one example, the event is related to panel/beam switch, the UE initiates/triggers a beam report when the UE detects a need for panel/switch, implying the UE needs to switch from the current panel/beam to another panel(s)/beam.
   In one example, the beam report in above examples can correspond to a full report (based on Rel.15-17 reportQuantity, i.e., ‘cri-RSRP’ or ‘ssb-Index-RSRP’ or ‘cri-SINR’, or ‘ssb-Index-SINR’ or ‘cri-RSRP-CapabilityIndex’ or ‘ssb-Index-RSRP-CapabilityIndex’ or ‘cri-SINR-CapabilityIndex’, or ‘ssb-Index-SINR-CapabilityIndex’) or a partial report (e.g., only report without beam metric, i.e., ‘cri’ or ‘ssb-Index’ or ‘cri-CapabilityIndex’ or ‘ssb-Index-CapabilityIndex’).
In one example, for a CSI-related event-type, at least one of the examples can be used as an event.
   In one example, the event is related to transmission/decoding failure or BLER, e.g., the UE initiates/triggers a CSI report when the event is detected, implying the transmission/decoding failure may happen (or BLER may exceed a threshold) with the current transmission or last reported CSI.
   In one example, the event is related to a CSI parameter from (PMI, RI, CQI, CRI, LI). For example, the event is related to CQI, e.g., the UE initiates/triggers a CSI (or CQI) report when the event is detected, implying the transmission/decoding failure may happen (or BLER may exceed a threshold) with the current transmission or last reported CSI (or CQI).
   In one example, for CSI across multiple TRPs (or multiple CSI-RS resources), the event is related to TRP/resource selection/switch (e.g., sTRP/CJT/NCJT), e.g., the UE initiates/triggers a CSI report when the event is detected, implying the set of multiple TRPs/resources needs to be updated (otherwise the transmission/decoding failure may happen or BLER may exceed a threshold). The updated set can corresponds to adding/removing one or more TRPs from the set, and transmitting the updated CSI for the updated set.
   In one example, the CSI report in above examples can correspond to a full report (based on Rel.15-17 reportQuantity, i.e., ‘cri-RI-PMI-CQI’, or ‘cri-RI-LI-PMI-CQI’ or ‘cri-RI-i1’ or ‘cri-RI-CQI’ or ‘cri-RI-i1-CQI’) or a partial report (e.g., without RI, i.e., ‘cri-PMI-CQI’, or ‘cri-LI-PMI-CQI’ or ‘cri-i1’ or ‘cri-CQI’ or ‘cri-i1-CQI’).
In one example, for a TDCP-related event-type, at least one of the examples can be used as an event.
   In one example, the event is related to transmission/decoding failure or BLER, e.g., the UE initiates/triggers a TDCP report when the event is detected, implying the transmission/decoding failure may happen (or BLER may exceed a threshold) with the current transmission or last reported TDCP.
   In one example, the event is related to Doppler profile (e.g., which can be measurement via TRS resources), e.g., the UE initiates/triggers a TDCP report when the event is detected, implying that the Doppler spread or Doppler shift or relative Doppler spread or relative Doppler shift has exceeded a threshold.
   In one example, the event is related to auto-correlation profile (e.g., which can be measurement via TRS resources), e.g., the UE initiates/triggers a TDCP report when the event is detected, implying that the auto-correlation value (e.g., corresponding to a delay/lag) has exceeded a threshold.
In one example, for a non-CSI/beam/TDCP-related event-type, at least one of the examples can be used as an event.
   In one example, the event is related to beam indication, e.g., the UE initiates/triggers a beam indication (e.g., TCI state indication) when the event is detected, implying that a beam/transmission failure may happen with the current beam.
   In one example, the event is related to beam switch, e.g., the UE initiates/triggers a beam switch when the event is detected, implying that a beam/transmission failure may happen if beam switch does not happen.
   In one example, the event is related to SRS configuration, e.g., the UE initiates/triggers reporting of a number of SRS ports when the event is detected, implying that the UE needs to switch from N1-port SRS to N2-port SRS, where N₁≠N₂.
   In one example, the event is related to an RS, e.g., SRS (AP/SP SRS) or CSI-RS (AP/SP CSI-RS).

In one example, the event can be based on (corresponds to) comparing a metric (M) with a threshold (t).
In one example, if M≤t, the event is detected or declared positive.
In one example, if M<t, the event is detected or declared positive.
In one example, if M≥t, the event is detected or declared positive.
In one example, if M>t, the event is detected or declared positive.
In one example, if M=t, the event is detected or declared positive.

In one example, the event can be based on (corresponds to) comparing a metric (M) with two thresholds (t₁, t₂), e.g., a max value and a min value.
In one example, if t₁≤M≤ t₂, the event is detected or declared positive.
In one example, if t₁<M≤ t₂, the event is detected or declared positive.
In one example, if t₁≤M<t₂, the event is detected or declared positive.
In one example, if t₁<M<t₂, the event is detected or declared positive.

In one example, the event can be based on (corresponds to) comparing a metric (M) with a set of values S.
In one example, if M∈S, the event is detected or declared positive.
In one example, if M∉S, the event is detected or declared positive.

For beam, the metric can be power, RSRP, or, SINR. For CSI, the metric can be UE speed, PDSCH decoding failure (increasing decoding error), or increasing retransmission requests. For TDCP, the metric can be UE speed, or Doppler spread, or auto-correlation value.

Some information about the event can be configured (e.g., via RRC), or reported by the UE (e.g., via trigger/message).

### Component 1. Association of Event(s)/Event-Type(s)/Report-Type(s)

UE-Initiated/Triggered Reporting (Config) Associated with Event(s)

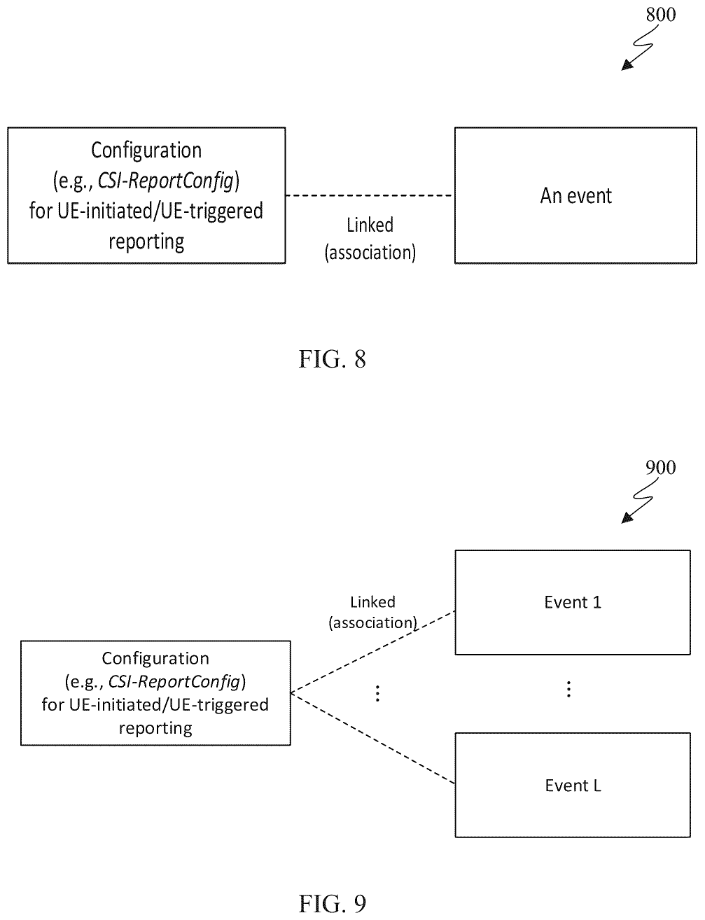

FIG. 8 illustrates an example of a configuration 800 for UE-initiated/UE-triggered reporting being associated with a single event according to embodiments of the present disclosure. The embodiment of the configuration 800 for UE-initiated/UE-triggered reporting being associated with a single event shown in FIG. 8 is for illustration only. Other embodiments of the configuration 800 for UE-initiated/UE-triggered reporting being associated with a single event could be used without departing from the scope of this disclosure.

In one embodiment, a configuration for UE-initiated/UE-triggered reporting can be associated with (linked to) one or multiple events, wherein an event can be pre-determined, fixed, or configured via DCI, MAC-CE, or RRC, or determined and reported by UE.

In one example, the configuration for UE-initiated/UE-triggered reporting can be associated with (linked to) a single event. In this case, when the single event is detected (or the criteria of the event are met), the UE can perform UE-initiated/UE-triggered reporting. Since only one event is associated with the configuration, NW can be aware of the associated event that occurred at the UE side when the UE performs UE-initiated/UE-triggered reporting. Hence, there is no need to indicate which event is detected in UE-initiated report. FIG. 8 shows an illustration of the configuration for UE-initiated/UE-triggered reporting being associated with a single event.

FIG. 9 illustrates an example of a configuration 900 for UE-initiated/UE-triggered reporting being associated with multiple events according to embodiments of the present disclosure. The embodiment of the configuration 900 for UE-initiated/UE-triggered reporting being associated with multiple events shown in FIG. 9 is for illustration only. Other embodiments of the configuration 900 for UE-initiated/UE-triggered reporting being associated with multiple events could be used without departing from the scope of this disclosure.

In one example, the configuration for UE-initiated/UE-triggered reporting can be associated with (linked to) L>1 multiple events. In this case, when some or all of the events are detected (or the criteria of some or all of the events are met), the UE can perform UE-initiated/UE-triggered reporting. FIG. 9 shows an illustration of the configuration for UE-initiated/UE-triggered reporting being associated with multiple events.

In one example, only when all of the L events are detected (or the criteria of all of the events are met), the UE can perform UE-initiated/UE-triggered reporting. Since, in this case, the UE-initiated/UE-triggered reporting happens only when all events are detected, NW can be aware of all events that occurred at the UE side when the UE performs UE-initiated/UE-triggered reporting. Hence, there is no need to indicate which event is detected in UE-initiated report.

In one example, when at least one (or a subset) of the L events is/are detected (or the criteria of at least one of the events are met), the UE can perform UE-initiated/UE-triggered reporting. In this case, the UE can report which events are detected.
In one example, if L′ out of the L events are detected, an L-bit bitmap indicator can be used to indicate L′ events that are detected. In one example, the indicator can be jointly reported along with UE-initiated/UE-triggered reporting. In another example, the indicator can be separately reported.
In one example, if L′ out of the L events are detected, an indicator with size of ┌log₂ L┐ bits to indicate the value of L′ and a combinatorial indicator with size of

$$⌈ {log}_{2} ( \begin{matrix}L \\ {L}^{′}\end{matrix} ) ⌉ bits$$

to indicate the selection of L′ out of the L events can be used to indicate L′ events that are detected. In one example, the indicator can be jointly reported along with UE-initiated/UE-triggered reporting. In another example, the indicator can be separately reported. In one example, one indicator (e.g., ┌log₂ L┐-bit indicator) can be in UCI part 1 and the other indicator

$$( e . g . , ⌈ {log}_{2} ( \begin{matrix}L \\ {L}^{′}\end{matrix} ) ⌉ - bit indicator )$$

can be in UCI part 2. In one example, the two indicators can be in UCI part 1. In one example, the two indicators can be in UCI part 2.
In one example, when multiple events are detected out of the L events, only one event is selected and reported among the detected events. In this case, an indicator with size of ┌log₂ L┐ bits to indicate the detected event can be used. In one example, the selection can be determined by a pre-determined rule or priority rule, or by the UE. In this case, the indicator could not be needed, since it is deterministic. For example, a pre-determine rule can be fixed in the order of beam-related event>CSI-related event>TDCP-related event>non-CSI related event. In another example, any other order of events can be applied for the selection (e.g., CSI>beam>TDCP>non-CSI).
In one example, when multiple events are detected out of the L events, only up to L events are selected and reported among the detected events. In this case, an indicator with size of ┌log₂ L̅┐ bits and a combinatorial indicator with size of

$$⌈ {log}_{2} ( \begin{matrix}L \\ \overline{L}\end{matrix} ) ⌉ bits$$

to indicate the selection of L̅ out of the L events can be used to indicate up to L̅ events that are detected. In one example, the indicator can be jointly reported along with UE-initiated/UE-triggered reporting. In another example, the indicator can be separately reported. In one example, one indicator (e.g., ┌log₂ L̅┐-bit indicator) can be in UCI part 1 and the outer indicator

$$( e . g . , ⌈ {log}_{2} ( \begin{matrix}L \\ \overline{L}\end{matrix} ) ⌉ - bit indicator )$$

can be in UCI part 2. In one example, the two indicators can be in UCI part 1. In one example, the two indicators can be in UCI part 2. In one example, L can be configured by NW, or fixed, or determined by the UE.

In one example, the UE can report which events are detected implicitly when at least one (or a subset) of the L events is/are detected. For example, each event is associated with different (or independent) UL resource allocation in the configuration. The NW can be aware of which event(s) is(are) detected at the UE side implicitly by sounding (receiving) associated UL resources when the UE performs UE-initiated/UE-triggered reporting.

In one embodiment, no event is associated with (linked to) a configuration for UE-initiated/UE-triggered reporting. In this case, the UE can determine a need of UE-initiated/UE-triggered reporting autonomously. Since, in this case, not being aware of an associated event, the NW can only rely on the content and/or trigger/pre-notification message of UE-initiated/UE-triggered report to understand the situation of the UE side.

UE-Initiated/Triggered Reporting (Config) Associated with Event-Type(s)

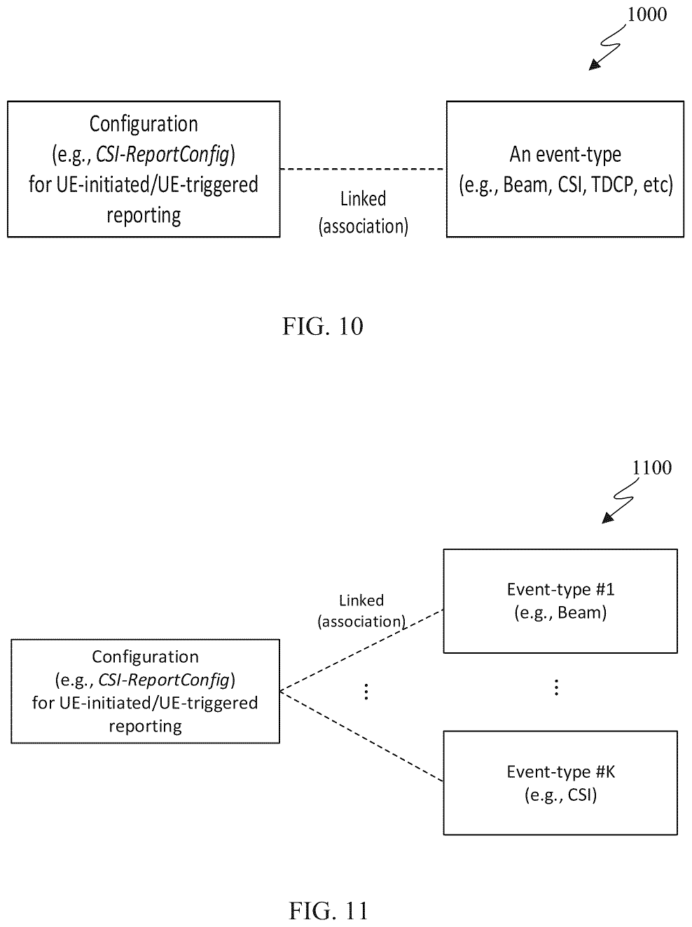

FIG. 10 illustrates an example of a configuration 1000 for UE-initiated/UE-triggered reporting being associated with a single event-type according to embodiments of the present disclosure. The embodiment of the configuration 1000 for UE-initiated/UE-triggered reporting being associated with a single event-type shown in FIG. 10 is for illustration only. Other embodiments of the configuration 1000 for UE-initiated/UE-triggered reporting being associated with a single event-type could be used without departing from the scope of this disclosure.

In one embodiment, a configuration for UE-initiated/UE-triggered reporting can be associated with (linked to) one or multiple event types, wherein an event-type can be (pre-determined, fixed, or) configured via DCI, MAC-CE, or RRC, or determined and reported by UE.

In one example, the configuration for UE-initiated/UE-triggered reporting can be associated with (linked to) a single event-type. In this case, when the UE detects a need for UE-initiated/UE-triggered reporting associated with the single event-type, the UE can perform UE-initiated/UE-triggered reporting. Since only one event-type is associated with the configuration, NW can be aware of the associated event-type at the UE side when the UE performs UE-initiated/UE-triggered reporting. Hence, there is no need to indicate which event-type is triggered for the UE-initiated report. FIG. 10 shows an illustration of the configuration for UE-initiated/UE-triggered reporting being associated with a single event-type.

FIG. 11 illustrates an example of a configuration 1100 for UE-initiated/UE-triggered reporting being associated with multiple event types according to embodiments of the present disclosure. The embodiment of the configuration 1100 for UE-initiated/UE-triggered reporting being associated with multiple event types shown in FIG. 11 is for illustration only. Other embodiments of the configuration 1100 for UE-initiated/UE-triggered reporting being associated with multiple event types could be used without departing from the scope of this disclosure.

In one example, the configuration for UE-initiated/UE-triggered reporting can be associated with (linked to) K>1 multiple event types. In this case, when the UE detects a need for UE-initiated/UE-triggered reporting associated with some or all of the event-types, the UE can perform UE-initiated/UE-triggered reporting. FIG. 11 shows an illustration of the configuration for UE-initiated/UE-triggered reporting being associated with multiple event types.

In one example, only when the UE detects a need for UE-initiated/UE-triggered reporting associated with all of the K event types, the UE can perform UE-initiated/UE-triggered reporting. Since, in this case, the UE-initiated/UE-triggered reporting happens only when reporting is performed for all event types, NW can be aware of all associated event types at the UE side when the UE performs UE-initiated/UE-triggered reporting. Hence, there is no need to indicate which event-type is associated with the (current) UE-initiated/UE-triggered report.

In one example, when the UE detects a need for UE-initiated/UE-triggered reporting associated with at least one (or a subset) of the K event types, the UE can perform UE-initiated/UE-triggered reporting. In this case, the UE can report which event types are associated with the (current) UE-initiated/UE-triggered report.
In one example, if UE-initiated/UE-triggered reporting associated with K′ out of the K event types is needed, an K-bit bitmap indicator can be used to indicate K′ event types that are associated with the report. In one example, the indicator can be jointly reported along with UE-initiated/UE-triggered reporting. In another example, the indicator can be separately reported.
In one example, if UE-initiated/UE-triggered reporting associated with K′ out of the K event types is needed, an indicator with size of ┌log₂ K┐ bits to indicate the value of K′ and a combinatorial indicator with size of

$$⌈ {log}_{2} ( \begin{matrix}K \\ {K}^{′}\end{matrix} ) ⌉ bits$$

to indicate the selection of K′ out of the K event types can be used to indicate K′ event types that are associated with the report. In one example, the indicator can be jointly reported along with UE-initiated/UE-triggered reporting. In another example, the indicator can be separately reported. In one example, one indicator (e.g., ┌log₂ K┐-bit indicator) can be in UCI part 1 and the other indicator

$$( e . g . , ⌈ {log}_{2} ( \begin{matrix}K \\ {K}^{′}\end{matrix} ) ⌉ - bit indicator )$$

can be in UCI part 2. In one example, the two indicators can be in UCI part 1. In one example, the two indicators can be in UCI part 2.
In one example, when UE-initiated/UE-triggered reporting associated with multiple event types out of the K event types is needed, only one event-type is selected and reported among the multiple event types. In this case, an indicator with size of ┌log₂ K┐ bits to indicate the event type can be used. In one example, the selection can be determined by a pre-determined rule or priority rule, or by the UE. In this case, the indicator could not be needed, since it is deterministic. For example, a pre-determine rule can be fixed in the order of beam-related event>CSI-related event>TDCP-related event>non-CSI related event. In another example, any other order of events can be applied for the selection (e.g., CSI>beam>TDCP>non-CSI).
In one example, when UE-initiated/UE-triggered reporting associated with multiple event types out of the K event types is needed, only up to K̅ event types are selected and reported among the multiple event types. In this case, an indicator with size of ┌log₂ K̅┐ bits and a combinatorial indicator with size of

$$⌈ {log}_{2} ( \begin{matrix}K \\ \overline{K}\end{matrix} ) ⌉ bits$$

to indicate the selection of K out of the K event types can be used to indicate up to K̅ event types. In one example, the indicator can be jointly reported along with UE-initiated/UE-triggered reporting. In another example, the indicator can be separately reported. In one example, one indicator (e.g., ┌log₂ K̅┐-bit indicator) can be in UCI part 1 and the other indicator

$$( e . g . , ⌈ {log}_{2} ( \begin{matrix}K \\ \overline{K}\end{matrix} ) ⌉ - bit indicator )$$

can be in UCI part 2. In one example, the two indicators can be in UCI part 1. In one example, the two indicators can be in UCI part 2. In one example, K̅ can be configured by NW, or fixed, or determined by the UE.

In one example, the UE can implicitly report which event types are associated with the (current) UE-initiated/UE-triggered report when reporting associated with at least one (or a subset) of the K event types is needed. For example, each event type is associated with different (or independent) UL resource allocation in the configuration. The NW can be aware of which event type(s) is(are) related to the (current) UE-initiated/UE-triggered report implicitly by sounding (receiving) associated UL resources when the UE performs UE-initiated/UE-triggered reporting.

In one embodiment, no event type is associated with (linked to) a configuration for UE-initiated/UE-triggered reporting. In this case, the UE can determine a need of UE-initiated/UE-triggered reporting autonomously. Since, in this case, not being aware of an associated event type, the NW can only rely on the content and/or trigger/pre-notification message of UE-initiated/UE-triggered report to understand the situation of the UE side.

UE-Initiated/Triggered Reporting (Config) Associated with Event-Type(s) and Event(s)

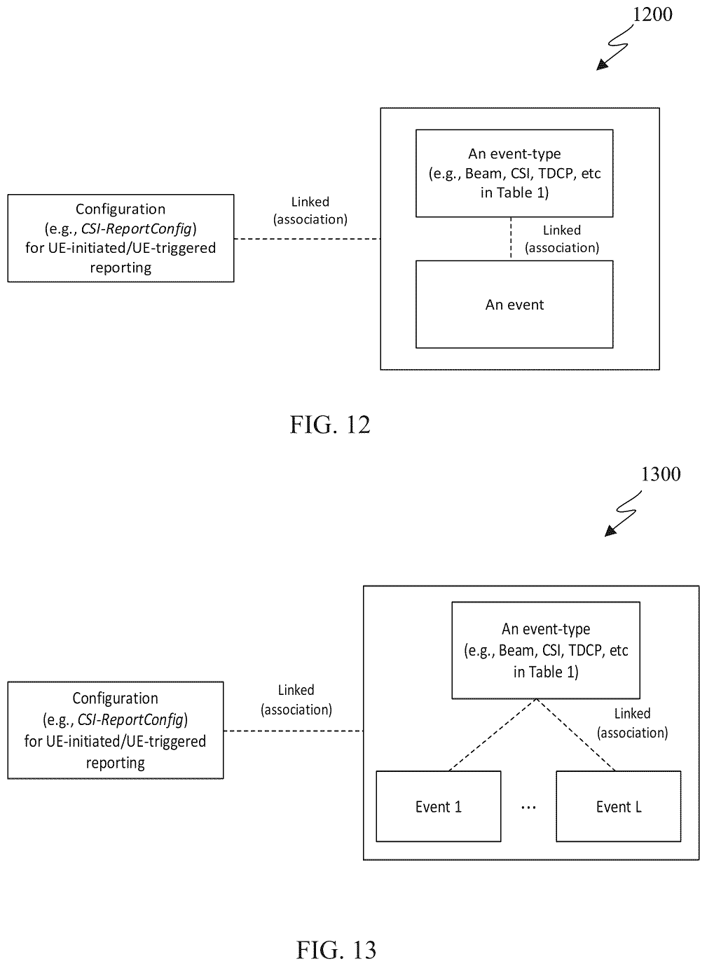

FIG. 12 illustrates a configuration 1200 for UE-initiated/UE-triggered reporting being associated with a single event-type and an event, where the single event-type is linked to or associated with the event according to embodiments of the present disclosure. The embodiment of the configuration 1200 for UE-initiated/UE-triggered reporting being associated with a single event-type and an event, where the single event-type is linked to or associated with the event shown in FIG. 12 is for illustration only. Other embodiments of the configuration 1200 for UE-initiated/UE-triggered reporting being associated with a single event-type and an event, where the single event-type is linked to or associated with the event could be used without departing from the scope of this disclosure.

In one embodiment, a configuration for UE-initiated/UE-triggered reporting can be associated with (linked to) one or multiple event types and one or multiple event(s), wherein an event-type can be (pre-determined, fixed, or) configured via DCI, MAC-CE, or RRC, or determined and reported by UE, and an event can be pre-determined, fixed, or configured via DCI, MAC-CE, or RRC, or determined and reported by UE.

In one example, the configuration for UE-initiated/UE-triggered reporting can be associated with (linked to) a single event type and a single event, wherein the single event can be associated with the single event type. In this case, when the single event is detected (or the criteria of the event are met), the UE can perform UE-initiated/UE-triggered reporting. Since only one event is associated with the single event type in the configuration, NW can be aware of the associated event type and the event that occurred at the UE side when the UE performs UE-initiated/UE-triggered reporting. Hence, there is no need to indicate which event is detected nor which event-type is associated in the UE-initiated report. FIG. 12 shows an illustration of the configuration for UE-initiated/UE-triggered reporting being associated with a single event-type and an event, wherein the single event-type is linked to or associated with the event.

FIG. 13 illustrates a configuration 1300 for UE-initiated/UE-triggered reporting being associated with a single event-type and multiple events, where the single event-type is linked to or associated with the multiple events according to embodiments of the present disclosure. The embodiment of the configuration 1300 for UE-initiated/UE-triggered reporting being associated with a single event-type and multiple events, where the single event-type is linked to or associated with the multiple events shown in FIG. 13 is for illustration only. Other embodiments of the configuration 1300 for UE-initiated/UE-triggered reporting being associated with a single event-type and multiple events, where the single event-type is linked to or associated with the multiple events could be used without departing from the scope of this disclosure.

In one example, the configuration for UE-initiated/UE-triggered reporting can be associated with (linked to) a single event type and L>1 multiple events, wherein the single event can be associated with the L>1 multiple events. In this case, when some or all of the events are detected (or the criteria of some or all of the events are met), the UE can perform UE-initiated/UE-triggered reporting. FIG. 13 shows an illustration of the configuration for UE-initiated/UE-triggered reporting being associated with a single event-type and multiple events, wherein the single event type is linked to or associated with the multiple events.

In one example, only when all of the L events are detected (or the criteria of all of the events are met), the UE can perform UE-initiated/UE-triggered reporting. Since, in this case, the UE-initiated/UE-triggered reporting happens only when all events are detected, NW can be aware of the associated event type and all events that occurred at the UE side when the UE performs UE-initiated/UE-triggered reporting. Hence, there is no need to indicate which event is detected in UE-initiated report.

In one example, when at least one (or a subset) of the L events is/are detected (or the criteria of at least one of the events are met), the UE can perform UE-initiated/UE-triggered reporting. In this case, the UE can report which events are detected.
In one example, if L′ out of the L events are detected, an L-bit bitmap indicator can be used to indicate L′ events that are detected. In one example, the indicator can be jointly reported along with UE-initiated/UE-triggered reporting. In another example, the indicator can be separately reported.
In one example, if L′ out of the L events are detected, an indicator with size of ┌log₂ L┐ bits to indicate the value of L′ and a combinatorial indicator with size of

$$⌈ {log}_{2} ( \begin{matrix}L \\ {L}^{′}\end{matrix} ) ⌉ bits$$

to indicate the selection of L′ out of the L events can be used to indicate L′ events that are detected. In one example, the indicator can be jointly reported along with UE-initiated/UE-triggered reporting. In another example, the indicator can be separately reported. In one example, one indicator (e.g., ┌log₂ L┐-bit indicator) can be in UCI part 1 and the other indicator

$$( e . g . , ⌈ {log}_{2} ( \begin{matrix}L \\ {L}^{′}\end{matrix} ) ⌉ - bit indicator )$$

can be in UCI part 2. In one example, the two indicators can be in UCI part 1. In one example, the two indicators can be in UCI part 2.
In one example, when multiple events are detected out of the L events, only one event is selected and reported among the detected events. In this case, an indicator with size of ┌log₂ L┐ bits to indicate the detected event can be used. In one example, the selection can be determined by a pre-determined rule or priority rule, or by the UE. In this case, the indicator could not be needed, since it is deterministic. For example, a pre-determine rule can be fixed in the order of beam-related event>CSI-related event>TDCP-related event>non-CSI related event. In another example, any other order of events can be applied for the selection (e.g., CSI>beam>TDCP>non-CSI).
In one example, when multiple events are detected out of the L events, only up to L events are selected and reported among the detected events. In this case, an indicator with size of ┌log₂ L┐ bits and a combinatorial indicator with size of

$$⌈ {log}_{2} ( \begin{matrix}L \\ \overline{L}\end{matrix} ) ⌉ bits$$

to indicate the selection of L̅ out of the L events can be used to indicate up to L̅ events that are detected. In one example, the indicator can be jointly reported along with UE-initiated/UE-triggered reporting. In another example, the indicator can be separately reported. In one example, one indicator (e.g., ┌log₂ L┐-bit indicator) can be in UCI part 1 and the other indicator

$$( e . g . , ⌈ {log}_{2} ( \begin{matrix}L \\ \overline{L}\end{matrix} ) ⌉ - bit indicator )$$

can be in UCI part 2. In one example, the two indicators can be in UCI part 1. In one example, the two indicators can be in UCI part 2. In one example, L can be configured by NW, or fixed, or determined by the UE.

In one example, the UE can report which events are detected implicitly when at least one (or a subset) of the L events is/are detected. For example, each event is associated with different (or independent) UL resource allocation in the configuration. The NW can be aware of which event(s) is(are) detected at the UE side implicitly by sounding (receiving) associated UL resources when the UE performs UE-initiated/UE-triggered reporting.

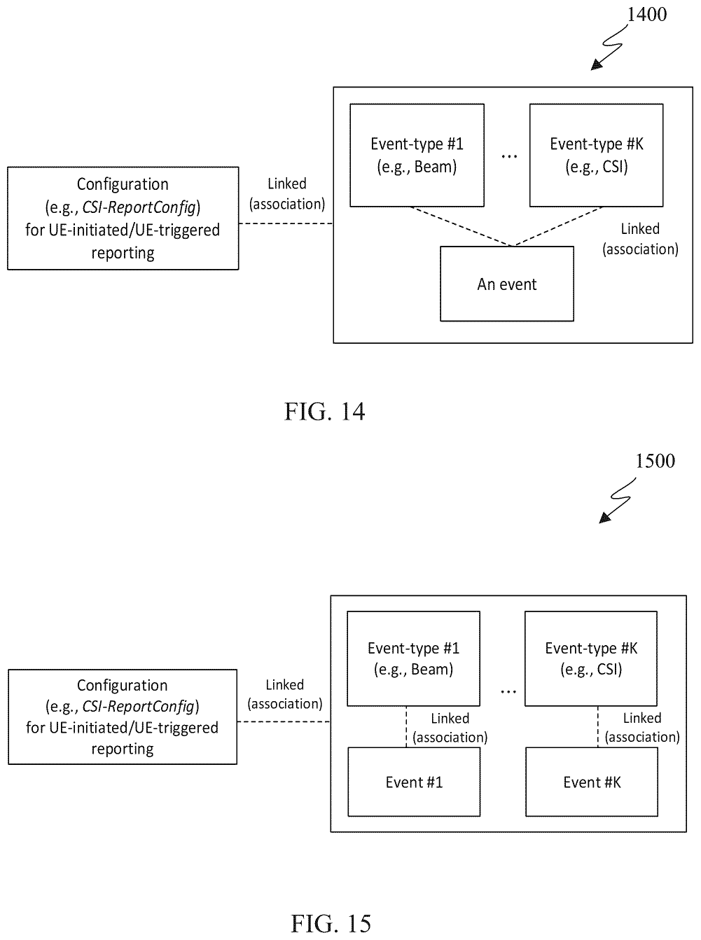

FIG. 14 illustrates an example of a configuration 1400 for UE-initiated/UE-triggered reporting being associated with multiple event types and a single event, wherein the multiple event types are associated with the single event according to embodiments of the present disclosure. The embodiment of the configuration 1400 for UE-initiated/UE-triggered reporting being associated with multiple event types and a single event, wherein the multiple event types are associated with the single event shown in FIG. 14 is for illustration only. Other embodiments of the configuration 1400 for UE-initiated/UE-triggered reporting being associated with multiple event types and a single event, wherein the multiple event types are associated with the single event could be used without departing from the scope of this disclosure.

In one example, the configuration for UE-initiated/UE-triggered reporting can be associated with (linked to) K>1 multiple event types and a single event, wherein the multiple event types are associated with the single event. In this case, when the single event is detected (or the criteria of the event are met), the UE can perform UE-initiated/UE-triggered reporting associated with some or all of the multiple event types. FIG. 14 shows an illustration of the configuration for UE-initiated/UE-triggered reporting being associated with multiple event types and a single event, wherein the multiple event types are associated with the single event.

In one example, when the single event is detected (the criteria of the event are met), the UE can only perform UE-initiated/UE-triggered reporting associated with all of the K event types. Since, in this case, the UE-initiated/UE-triggered reporting associated with all of the K event types can only happen, NW can expect to receive information on all of the K event types when the UE performs UE-initiated/UE-triggered reporting. Hence, there is no need to indicate which event-type is associated with the (current) UE-initiated/UE-triggered report.

In one example, when the single event is detected (the criteria of the event are met), the UE can perform UE-initiated/UE-triggered reporting associated with at least one (or a subset) of the K event types. In this case, the UE can (needs to) report which event types are associated with the (current) UE-initiated/UE-triggered report.
In one example, if UE-initiated/UE-triggered reporting associated with K′ out of the K event types is needed (e.g., K′ can be determined by the UE), an K-bit bitmap indicator can be used to indicate K′ event types that are associated with the report. In one example, the indicator can be jointly reported along with UE-initiated/UE-triggered reporting. In another example, the indicator can be separately reported.
In one example, if UE-initiated/UE-triggered reporting associated with K′ out of the K event types is needed (e.g., K′ can be determined by the UE), an indicator with size of ┌log₂ K┐ bits to indicate the value of K′ and a combinatorial indicator with size of

$$⌈ {log}_{2} ( \begin{matrix}K \\ {K}^{′}\end{matrix} ) ⌉ bits$$

to indicate the selection of K′ out of the K event types can be used to indicate K′ event types that are associated with the report. In one example, the indicator can be jointly reported along with UE-initiated/UE-triggered reporting. In another example, the indicator can be separately reported. In one example, one indicator (e.g., ┌log₂ K┐-bit indicator) can be in UCI part 1 and the other indicator

$$( e . g . , ⌈ {log}_{2} ( \begin{matrix}K \\ {K}^{′}\end{matrix} ) ⌉ - bit indicator )$$

can be in UCI part 2. In one example, the two indicators can be in UCI part 1. In one example, the two indicators can be in UCI part 2.
In one example, UE-initiated/UE-triggered reporting can be performed only for one event type out of the K event types. In this case, an indicator with size of ┌log₂ K┐ bits to indicate the event type can be used. In one example, the selection can be determined by the UE or a pre-determined rule or priority rule. For example, the reporting can be performed in a cycling manner, where each event type is reported one-by-one.
In one example, UE-initiated/UE-triggered reporting can be performed for only up to K event types out of the K event types. In this case, an indicator with size of ┌log₂ K┐ bits and a combinatorial indicator with size of

$$⌈ {log}_{2} ( \frac{K}{K} ) ⌉ bits$$

to indicate the selection of K out of the K event types can be used to indicate up to K event types. In one example, the indicator can be jointly reported along with UE-initiated/UE-triggered reporting. In another example, the indicator can be separately reported. In one example, one indicator (e.g., ┌log₂ K̅┐-bit indicator) can be in UCI part 1 and the other indicator

$$( e . g . , ⌈ {log}_{2} ( \frac{K}{K} ) ⌉ - bit indicator )$$

can be in UCI part 2. In one example, the two indicators can be in UCI part 1. In one example, the two indicators can be in UCI part 2. In one example, K̅ can be configured by NW, or fixed/pre-determined, or determined by the UE.

In one example, the UE can implicitly report which event types are associated with the (current) UE-initiated/UE-triggered report when the single event is detected. For example, each event type is associated with different (or independent) UL resource allocation in the configuration. The NW can be aware of which event type(s) is(are) related to the (current) UE-initiated/UE-triggered report implicitly by sounding (receiving) associated UL resources when the UE performs UE-initiated/UE-triggered reporting.

FIG. 15 illustrates a configuration 1500 for UE-initiated/UE-triggered reporting being associated with multiple event types and multiple events, wherein each event type is associated with each event according to embodiments of the present disclosure. The embodiment of the configuration 1500 for UE-initiated/UE-triggered reporting being associated with multiple event types and multiple events, wherein each event type is associated with each event shown in FIG. 15 is for illustration only. Other embodiments of the configuration 1500 for UE-initiated/UE-triggered reporting being associated with multiple event types and multiple events, wherein each event type is associated with each event could be used without departing from the scope of this disclosure.

In one example, the configuration for UE-initiated/UE-triggered reporting can be associated with (linked to) K>1 multiple event types and K>1 multiple events, wherein each event type is associated with each event (i.e., one-to-one association). In this case, when some or all of the events are detected (or the criteria of the events are met), the UE can perform UE-initiated/UE-triggered reporting associated with some or all of the multiple event types that are linked to the detected events. FIG. 15 shows an illustration of the configuration for UE-initiated/UE-triggered reporting being associated with multiple event types and multiple events, wherein each event type is associated with each event.

In one example, only when all of the K events are detected (or the criteria of all of the events are met), the UE can perform UE-initiated/UE-triggered reporting. Since, in this case, the UE-initiated/UE-triggered reporting happens only when all events are detected, NW can be aware of all of the associated event types and events that occurred at the UE side when the UE performs UE-initiated/UE-triggered reporting. Hence, there is no need to indicate which event is detected in UE-initiated report.

In one example, when at least one (or a subset) of the K events is/are detected (or the criteria of at least one of the events are met), the UE can perform UE-initiated/UE-triggered reporting. In this case, the UE can report which events are detected so that the corresponding event types can be indicated.
In one example, if K′ out of the K events are detected, an K-bit bitmap indicator can be used to indicate K′ events that are detected. In one example, the indicator can be jointly reported along with UE-initiated/UE-triggered reporting. In another example, the indicator can be separately reported.
In one example, if K′ out of the K events are detected, an indicator with size of ┌log₂ K┐ bits to indicate the value of K′ and a combinatorial indicator with size of

$$⌈ {log}_{2} ( \begin{matrix}K \\ {K}^{′}\end{matrix} ) ⌉ bits$$

to indicate the selection of K′ out of the K events can be used to indicate K′ events that are detected. In one example, the indicator can be jointly reported along with UE-initiated/UE-triggered reporting. In another example, the indicator can be separately reported. In one example, one indicator (e.g., ┌log₂ K┐-bit indicator) can be in UCI part 1 and the other indicator

$$( e . g . , ⌈ {log}_{2} ( \frac{K}{{K}^{′}} ) ⌉ - bit indicator )$$

can be in UCI part 2. In one example, the two indicators can be in UCI part 1. In one example, the two indicators can be in UCI part 2.
In one example, when multiple events are detected out of the K events, only one event is selected and reported among the detected events. In this case, an indicator with size of ┌log₂ K┐ bits to indicate the detected event can be used. In one example, the selection can be determined by a pre-determined rule or priority rule, or by the UE. In this case, the indicator could not be needed, since it is deterministic. For example, a pre-determine rule can be fixed in the order of beam-related event>CSI-related event>TDCP-related event>non-CSI related event. In another example, any other order of events can be applied for the selection (e.g., CSI>beam>TDCP>non-CSI).
In one example, when multiple events are detected out of the K events, only up to K events are selected and reported among the detected events. In this case, an indicator with size of ┌log₂ K̅┐ bits and a combinatorial indicator with size of

$$⌈ {log}_{2} ( \frac{K}{K} ) ⌉ bits$$

to indicate the selection of K̅ out of the K events can be used to indicate up to K̅ events that are detected. In one example, the indicator can be jointly reported along with UE-initiated/UE-triggered reporting. In another example, the indicator can be separately reported. In one example, one indicator (e.g., ┌log₂ K̅┐-bit indicator) can be in UCI part 1 and the other indicator

$$( e . g . , ⌈ {log}_{2} ( \frac{K}{K} ) ⌉ - bit indicator )$$

can be in UCI part 2. In one example, the two indicators can be in UCI part 1. In one example, the two indicators can be in UCI part 2. In one example, K̅ can be configured by NW, or fixed, or determined by the UE.

In one example, the UE can report which events are detected implicitly when at least one (or a subset) of the K events is/are detected. For example, each event is associated with different (or independent) UL resource allocation in the configuration. The NW can be aware of which event(s) is(are) detected at the UE side implicitly by sounding (receiving) associated UL resources when the UE performs UE-initiated/UE-triggered reporting.

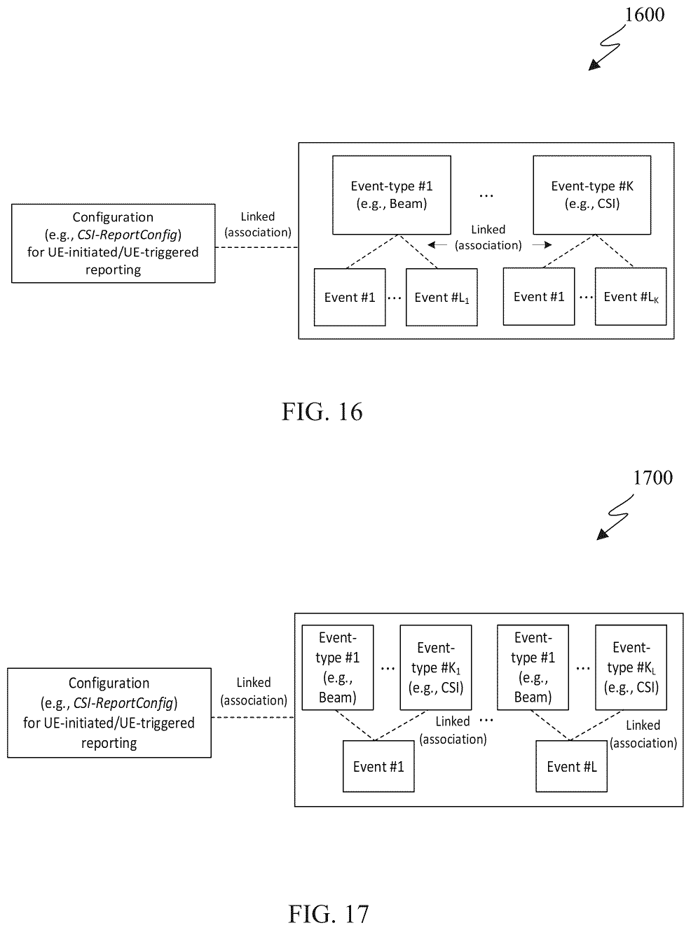

FIG. 16 illustrates a configuration 1600 for UE-initiated/UE-triggered reporting being associated with multiple event types and multiple events, wherein each event type is associated with multiple events according to embodiments of the present disclosure. The embodiment of the configuration 1600 for UE-initiated/UE-triggered reporting being associated with multiple event types and multiple events, wherein each event type is associated with multiple events shown in FIG. 16 is for illustration only. Other embodiments of the configuration 1600 for UE-initiated/UE-triggered reporting being associated with multiple event types and multiple events, wherein each event type is associated with multiple events could be used without departing from the scope of this disclosure.

In one example, the configuration for UE-initiated/UE-triggered reporting can be associated with (linked to) K>1 multiple event types, wherein each event type k is associated with Lₖ multiple events (i.e., many-to-one association). In one example, Lₖ=L for all k. In another example, Lₖ can be independent (same/different) across k. When some or all of the events are detected (or the criteria of the events are met), the UE can perform UE-initiated/UE-triggered reporting associated with some or all of the multiple event types that are associated with (linked to) the detected events. FIG. 16 shows an illustration of the configuration for UE-initiated/UE-triggered reporting being associated with multiple event types and multiple events, wherein each event type is associated with multiple events.

In one example, when some (or all) of events are detected, the UE can perform UE-initiated/UE-triggered reporting associated with some or all of the event types that are associated with the detected events. The UE can report which event-types are associated with the (current) UE-initiated/UE-triggered report (i.e., including event-type indicator/parameter but not event indicator/parameter).
In one example, only when all of the associated events for an event type are detected, the UE can perform UE-initiated/UE-triggered reporting associated with the event type.
In one example, when at least one of the associated events for an event type are detected, the UE can perform UE-initiated/UE-triggered reporting associated with the event type.

In the above examples, the UE can report which event-types are indicated according to at least one of the following examples:
In one example, a K-bit bitmap indicator can be used to indicate event types that are associated with the (current) UE-initiated/UE-triggered report.
In one example, a combinatorial indicator(s) can be used to indicate event types that are associated with the (current) UE-initiated/UE-triggered report. For example, an indicator with size of ┌log₂ K┐-bit to the number of event types and an indicator with size of

$$⌈ {log}_{2} ( \begin{matrix}K \\ {K}^{′}\end{matrix} ) ⌉ - bit$$

can be used. The two indicators can both be in UCI part 1 or both be in UCI part 2. Or one of them can be in UCI part 1 and the other can be in UCI part 2.
In one example, only one event-type can be selected and reported. In this case, an indicator with size of ┌log₂ K┐-bit can be needed. The selection for one event can be determined by UE or a pre-determined rule.
In one example, up to K̅ event-types can be selected and reported. In this case, an indicator with size of ┌log₂ K̅┐ bits and a combinatorial indicator with size of

$$⌈ {log}_{2} ( \begin{matrix}K \\ K\end{matrix} ) ⌉ bits$$

can be used. The two indicators can both be in UCI part 1 or both be in UCI part 2. Or one of them can be in UCI part 1 and the other can be in UCI part 2. In one example, K̅ can be configured by NW, or fixed, or determined by the UE.

In one example, when some (or all) of events are detected, the UE can perform UE-initiated/UE-triggered reporting associated with some or all of the event types that are associated with the detected events. The UE can report which event-types are associated with the (current) UE-initiated/UE-triggered report and which events are detected for each/some/all of the event types (i.e., including both event-type indicator/parameter and event indicator/parameter).
In one example, when at least one of the associated events for an event type are detected, the UE can perform UE-initiated/UE-triggered reporting associated with the event type.

In the above examples, the UE can report which event-types are indicated and which events are detected for each/some/all of the event types according to at least one of the following examples:
In one example (bit-map+bit-map), a K-bit bitmap indicator can be used to indicate event types that are associated with the (current) UE-initiated/UE-triggered report. For each event type k of the indicated event types, a Lₖ-bit bitmap indicator can be used to indicate events that are detected for the event type k.
In one example (bit-map+combinatorial), a K-bit bitmap indicator can be used to indicate event types that are associated with the (current) UE-initiated/UE-triggered report. For each event type k of the indicated event types, a combinatorial indicator(s) can be used to indicate events that are detected for the event type k. For example, an indicator with size of ┌log₂ Lₖ┐-bit to indicate the number of the detected events and an indicator with size of

$$⌈ {log}_{2} ( \begin{matrix}{L}_{k} \\ {L}_{k}^{′}\end{matrix} ) ] - bit$$

can be used for selecting the detected events.
In one example (bit-map+one event selection), a K-bit bitmap indicator can be used to indicate event types that are associated with the (current) UE-initiated/UE-triggered report. For each event type k of the indicated event types, a ┌log₂ Lₖ┐-bit indicator can be used to indicate one (representative) event. The selection for the event can be determined by UE, or by a pre-determined rule.
In one example (bit-map+up to x event selection), a K-bit bitmap indicator can be used to indicate event types that are associated with the (current) UE-initiated/UE-triggered report. For each event type k of the indicated event types, up to L̅ₖ events can be selected and reported. In this case, an indicator with size of ┌log₂ Lₖ┐ bits and a combinatorial indicator with size of

$$⌈ {log}_{2} ( \frac{{L}_{k}}{{L}_{k}} ) ⌉ bits$$

can be used. In one example, L̅ₖ can be configured by NW, or fixed, or determined by the UE.
In one example, a combinatorial indicator(s) can be used to indicate event types and a bitmap indicator can be used to indicate events for each of the event types (similarly extended from other examples in this disclosure).
In one example, a combinatorial indicator(s) can be used to indicate event types and a combinatorial indicator(s) can be used to indicate events for each of the event types (similarly extended from other examples in this disclosure).
In one example, a combinatorial indicator(s) can be used to indicate event types and an indicator can be used to indicate one event for each of the event types (similarly extended from other examples in this disclosure).
In one example, a combinatorial indicator(s) can be used to indicate event types and an indicator can be used to indicate up to x events for each of the event types (similarly extended from other examples in this disclosure).
In one example, an indicator can be used to indicate one event type and a bitmap indicator can be used to indicate events for the event type (similarly extended from other examples in this disclosure).
In one example, an indicator can be used to indicate one event type and a combinatorial indicator(s) can be used to indicate events for the event type (similarly extended from other examples in this disclosure).
In one example, an indicator can be used to indicate one event type and an indicator can be used to indicate one event for the event type (similarly extended from other examples in this disclosure).
In one example, an indicator can be used to indicate one event type and an indicator can be used to indicate up to x events for the event type (similarly extended from other examples in this disclosure).
In one example, an indicator can be used to indicate up to x event types and a bitmap indicator can be used to indicate events for each of the event types (similarly extended from other examples in this disclosure).
In one example, an indicator can be used to indicate up to x event types and a combinatorial indicator(s) can be used to indicate events for each of the event types (similarly extended from other examples in this disclosure).
In one example, an indicator can be used to indicate up to x event types and an indicator can be used to indicate one event for each of the event types (similarly extended from other examples in this disclosure).
In one example, an indicator can be used to indicate up to x event types and an indicator can be used to indicate up to y events for each of the event type (similarly extended from other examples in this disclosure).

In one example, event type indicator can be in UCI part 1 and event indicator can be in UCI part 2. In one example, both event type indicator and event indicator can be in UCI part 1 or in UCI part 2.

In one example, when some (or all) of events are detected, the UE can perform UE-initiated/UE-triggered reporting associated with some or all of the event types that are associated with the detected events. The UE can report which events are detected for the (current) UE-initiated/UE-triggered.
In one example, a Σ^{k} Lₖ-bit bitmap indicator can be used to indicate detected events.
In one example, a combinatorial indicator(s) can be used to indicate detected events. For example, an indicator with size of ┌log₂ Lₛᵤₘ┐-bit to the number of detected events for all event types and an indicator with size of

$$⌈ {log}_{2} ( \begin{matrix}{\sum }_{k} {L}_{k} \\ {L}_{sum}\end{matrix} ) ⌉ - bit$$

can be used. The two indicators can both be in UCI part 1 or both be in UCI part 2. Or one of them can be in UCI part 1 and the other can be in UCI part 2.
In one example, a combinatorial indicator(s) can be used to indicate detected events. For example, an indicator with size of ┌log₂ Lₖ┐-bit to the number of detected events for each event type k and an indicator with size of

$$⌈ {log}_{2} ( \begin{matrix}{L}_{k} \\ {L}_{k}^{′}\end{matrix} ) ⌉ - bit$$

can be used. The two indicators can both be in UCI part 1 or both be in UCI part 2. Or one of them can be in UCI part 1 and the other can be in UCI part 2.
In one example, only one detected event can be selected and reported for event type k. In this case, an indicator with size of ┌log₂ Lₖ┐-bit can be needed for the event type. The selection for one event can be determined by UE or a pre-determined rule.
In one example, up to Lₖ event-types can be selected and reported. In this case, an indicator with size of ┌log₂ Lₖ┐ bits and a combinatorial indicator with size of

$$⌈ {log}_{2} ( \frac{{L}_{k}}{{L}_{k}} ) ⌉ bits$$

can be used. The two indicators can both be in UCI part 1 or both be in UCI part 2. Or one of them can be in UCI part 1 and the other can be in UCI part 2. In one example, L̅ₖ can be configured by NW, or fixed, or determined by the UE.

FIG. 17 illustrates a configuration 1700 for UE-initiated/UE-triggered reporting being associated with multiple event types and multiple events, wherein each event is associated with multiple event types according to embodiments of the present disclosure. The embodiment of the configuration 1700 for UE-initiated/UE-triggered reporting being associated with multiple event types and multiple events, wherein each event is associated with multiple event types shown in FIG. 17 is for illustration only. Other embodiments of the configuration 1700 for UE-initiated/UE-triggered reporting being associated with multiple event types and multiple events, wherein each event is associated with multiple event types could be used without departing from the scope of this disclosure.

In one example, the configuration for UE-initiated/UE-triggered reporting can be associated with (linked to) L>1 multiple events, wherein each event l is associated with Kₗ multiple event types (i.e., one-to-many association). In one example, Kₗ=K for all l. In another example, Kₗ can be independent (same/different) across l. When some or all of the events are detected (or the criteria of the events are met), the UE can perform UE-initiated/UE-triggered reporting associated with some or all of the multiple event types that are associated with (linked to) the detected events. FIG. 17 shows an illustration of the configuration for UE-initiated/UE-triggered reporting being associated with multiple event types and multiple events, wherein each event is associated with multiple event types.

In one example, when some (or all) of events are detected, the UE can perform UE-initiated/UE-triggered reporting associated with some or all of the event types that are associated with the detected events. The UE can report which events are detected (i.e., including event indicator/parameter but not event type indicator/parameter).
In one example, the UE can perform UE-initiated/UE-triggered reporting on (all of the) associated event types for some or all detected events.

In the above examples, the UE can report which events are detected according to at least one of the following examples:
In one example, a L-bit bitmap indicator can be used to indicate detected events.
In one example, a combinatorial indicator(s) can be used to indicate detected events. For example, an indicator with size of ┌log₂ L┐-bit to the number of detected events and an indicator with size of

$$⌈ {log}_{2} ( \begin{matrix}L \\ {L}^{′}\end{matrix} ) ⌉ - bit$$

can be used to indicate the selection. The two indicators can both be in UCI part 1 or both be in UCI part 2. Or one of them can be in UCI part 1 and the other can be in UCI part 2.
In one example, only one event can be selected and reported. In this case, an indicator with size of ┌log₂ L┐-bit can be needed. The selection for one event can be determined by UE or a pre-determined rule.
In one example, up to L̅ events can be selected and reported. In this case, an indicator with size of ┌log₂ L̅┐ bits and a combinatorial indicator with size of

$$⌈ {log}_{2} ( \frac{L}{L} ) ⌉ bits$$

can be used. The two indicators can both be in UCI part 1 or both be in UCI part 2. Or one of them can be in UCI part 1 and the other can be in UCI part 2. In one example, L can be configured by NW, or fixed, or determined by the UE.

In one example, when some (or all) of events are detected, the UE can perform UE-initiated/UE-triggered reporting associated with some or all of the event types that are associated with the detected events. The UE can report which events are detected and which event types associated with the detected events are indicated to be included in the (current) UE-initiated/UE-triggered report (i.e., including both event indicator/parameter and event-type indicator/parameter).
In one example, the UE can perform UE-initiated/UE-triggered reporting for at least one of the associated event types for some or all detected events.

In the above examples, the UE can report which events are detected and which event types are indicated for each/some/all of the detected events according to at least one of the following examples:
In one example (bit-map+bit-map), a L-bit bitmap indicator can be used to indicate detected events. For each detected event l, a Kₗ-bit bitmap indicator can be used to indicate event types that are associated with the event l.
In one example (bit-map+combinatorial), a L-bit bitmap indicator can be used to indicate detected events. For each detected event l, a combinatorial indicator(s) can be used to indicate event types that are associated with the event l. For example, an indicator with size of ┌log₂ Kₗ┐-bit to indicate the number of the event types and an indicator with size of

$$⌈ {log}_{2} ( \begin{matrix}{K}_{l} \\ {K}_{l}^{′}\end{matrix} ) ⌉ ‐ bit$$

can be used for selecting the event types.
In one example (bit-map+one event-type selection), a L-bit bitmap indicator can be used to indicate detected events. For each detected event l, a ┌log₂ Kₗ┐-bit indicator can be used to indicate one (representative) event type. The selection for the event type can be determined by UE, or by a pre-determined rule.
In one example (bit-map+up to x event-type selection), a L-bit bitmap indicator can be used to indicate detected events. For each detected event l, up to K̅ event types can be selected and reported. In this case, an indicator with size of ┌log₂ Kₗ┐ bits and a combinatorial indicator with size of

$$⌈ {log}_{2} ( \begin{matrix}{K}_{l} \\ {\overline{K}}_{l}\end{matrix} ) ⌉ bits$$

can be used. In one example, K̅ₗ can be configured by NW, or fixed, or determined by the UE.
In one example, a combinatorial indicator(s) can be used to indicate detected events and a bitmap indicator can be used to indicate event types for each of the detected events (similarly extended from other examples in this disclosure).
In one example, a combinatorial indicator(s) can be used to indicate detected events and a combinatorial indicator(s) can be used to indicate event types for each of the detected events (similarly extended from other examples in this disclosure).
In one example, a combinatorial indicator(s) can be used to indicate detected events and an indicator can be used to indicate one event type for each of the detected events (similarly extended from other examples in this disclosure).
In one example, a combinatorial indicator(s) can be used to indicate detected events and an indicator can be used to indicate up to x event types for each of the detected events (similarly extended from other examples in this disclosure).
In one example, an indicator can be used to indicate one (representative) detected event and a bitmap indicator can be used to indicate event types for the detected event (similarly extended from other examples in this disclosure).
In one example, an indicator can be used to indicate one (representative) detected event and a combinatorial indicator(s) can be used to indicate event types for the detected event (similarly extended from other examples in this disclosure).
In one example, an indicator can be used to indicate one (representative) detected event and an indicator can be used to indicate one event type for the detected event (similarly extended from other examples in this disclosure).
In one example, an indicator can be used to indicate one (representative) detected event and an indicator can be used to indicate up to x event types for the detected event (similarly extended from other examples in this disclosure).
In one example, an indicator can be used to indicate up to x detected events and a bitmap indicator can be used to indicate event types for each of the detected events (similarly extended from other examples in this disclosure).
In one example, an indicator can be used to indicate up to x detected events and a combinatorial indicator(s) can be used to indicate event types for each of the detected events (similarly extended from other examples in this disclosure).
In one example, an indicator can be used to indicate up to x detected events and an indicator can be used to indicate one event type for each of the detected events (similarly extended from other examples in this disclosure).
In one example, an indicator can be used to indicate up to x detected events and an indicator can be used to indicate up to y event types for each of the detected events (similarly extended from other examples in this disclosure).

In one example, event type indicator can be in UCI part 1 and event indicator can be in UCI part 2. In one example, both event type indicator and event indicator can be in UCI part 1 or in UCI part 2.

In one example, when some (or all) of events are detected, the UE can perform UE-initiated/UE-triggered reporting associated with some or all of the event types that are associated with the detected events. The UE can report which event-types are associated with the (current) UE-initiated/UE-triggered report.
In one example, the UE can perform UE-initiated/UE-triggered reporting for at least one of the associated event types for some or all detected events.

In the above examples, the UE can report which event-types are indicated according to at least one of the following examples:
In one example, a Σₗ Kₗ-bit bitmap indicator can be used to indicate event types that are associated with the (current) UE-initiated/UE-triggered report.
In one example, a combinatorial indicator(s) can be used to indicate event types that are associated with the (current) UE-initiated/UE-triggered report. For example, an indicator with size of ┌log₂ Kₛᵤₘ┐-bit to the number of event types for all events and an indicator with size of

$$⌈ {log}_{2} ( \begin{matrix}{\sum }_{l} {K}_{l} \\ {K}_{s u m}\end{matrix} ) ⌉ ‐ bit$$

can be used. The two indicators can both be in UCI part 1 or both be in UCI part 2. Or one of them can be in UCI part 1 and the other can be in UCI part 2.
In one example, a combinatorial indicator(s) can be used to indicate event types that are associated with the (current) UE-initiated/UE-triggered report. For example, an indicator with size of ┌log₂ Kₗ′┐-bit to the number of event types for event l and an indicator with size of

$$⌈ {log}_{2} ( \begin{matrix}{K}_{l} \\ {K}_{l}^{′}\end{matrix} ) ⌉ ‐ bit$$

can be used. The two indicators can both be in UCI part 1 or both be in UCI part 2. Or one of them can be in UCI part 1 and the other can be in UCI part 2.
In one example, only one event-type can be selected and reported for each event l. In this case, an indicator with size of ┌log₂ Kₗ┐-bit can be needed. The selection for one event can be determined by UE or a pre-determined rule.
In one example, up to K̅ₗ event-types can be selected and reported. In this case, an indicator with size of ┌log₂ K̅ₗ┐ bits and a combinatorial indicator with size of

$$⌈ {log}_{2} ( \begin{matrix}{K}_{l} \\ {\overline{K}}_{l}\end{matrix} ) ⌉ bits$$

can be used. The two indicators can both be in UCI part 1 or both be in UCI part 2. Or one of them can be in UCI part 1 and the other can be in UCI part 2. In one example, K can be configured by NW, or fixed, or determined by the UE.

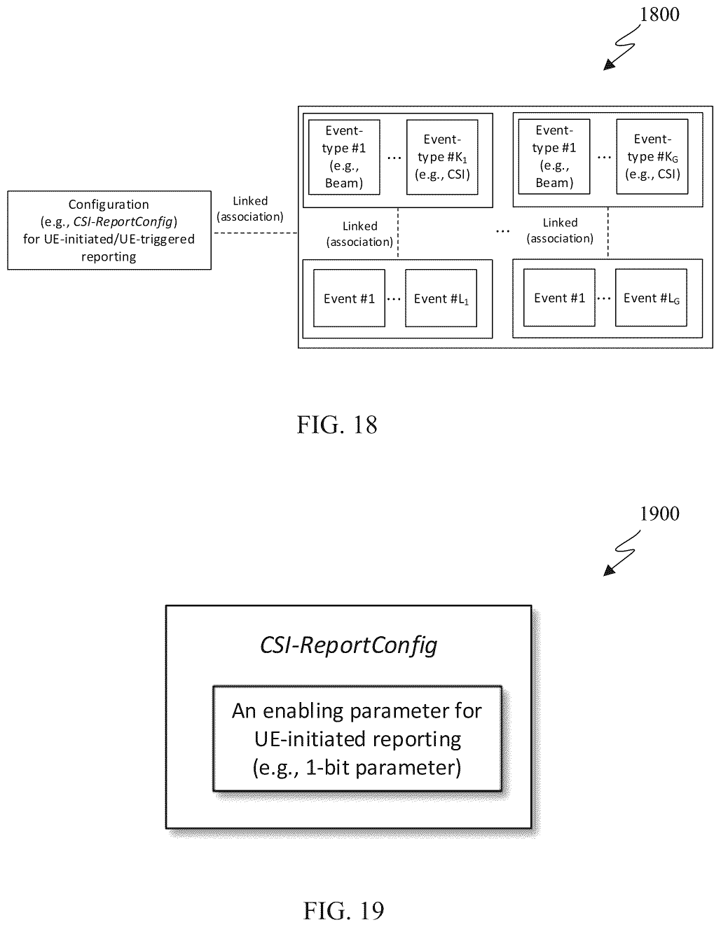

FIG. 18 illustrates a configuration 1800 for UE-initiated/UE-triggered reporting being associated with multiple event types and multiple events for each group, wherein multiple event types are associated with multiple events for each group according to embodiments of the present disclosure. The embodiment of the configuration 1800 for UE-initiated/UE-triggered reporting being associated with multiple event types and multiple events for each group, wherein multiple event types are associated with multiple events for each group shown in FIG. 18 is for illustration only. Other embodiments of the configuration 1800 for UE-initiated/UE-triggered reporting being associated with multiple event types and multiple events for each group, wherein multiple event types are associated with multiple events for each group could be used without departing from the scope of this disclosure.

In one example, the configuration for UE-initiated/UE-triggered reporting can be associated with (linked to) G groups of multiple events and multiple event types, wherein K_{g} multiple event types are associated with L_{g} events for each group g (i.e., many-to-many association). When some or all of the events are detected (or the criteria of the events are met), the UE can perform UE-initiated/UE-triggered reporting associated with some or all of the multiple event types that are associated with (linked to) the detected events. FIG. 18 shows an illustration of the configuration for UE-initiated/UE-triggered reporting being associated with multiple event types and multiple events for each group, wherein multiple event types are associated with multiple events for each group.

Extension to the Case of UE-Initiated/Triggered Reporting (Config) Associated with Report-Type(s)

In one embodiment, a configuration for UE-initiated/UE-triggered reporting can be associated with (linked to) one or multiple report types, wherein a report-type can be (pre-determined, fixed, or) configured via DCI, MAC-CE, or RRC, or determined and reported by UE.

Similar to examples described d herein, indicators/parameters can be defined/supported for association of UE-initiated/triggered reporting with report-type(s).

Extension to the Case of UE-Initiated/Triggered Reporting (Config) Associated with Event and Report-Type(s)

In one embodiment, a configuration for UE-initiated/UE-triggered reporting can be associated with (linked to) one or multiple report types and one or multiple event(s), wherein an report-type can be (pre-determined, fixed, or) configured via DCI, MAC-CE, or RRC, or determined and reported by UE, and an event can be pre-determined, fixed, or configured via DCI, MAC-CE, or RRC, or determined and reported by UE.

Similar to examples described herein, indicators/parameters can be defined for association of UE-initiated/triggered reporting with event and report-type(s).

Extension to the Case of UE-Initiated/Triggered Reporting (Config) Associated with Event and Event-Type(s) and Report-Type(s)

In one embodiment, a configuration for UE-initiated/UE-triggered reporting can be associated with (linked to) one or multiple report types and one or multiple event(s), wherein an report-type and an event-type can be (pre-determined, fixed, or) configured via DCI, MAC-CE, or RRC, or determined and reported by UE, and an event can be pre-determined, fixed, or configured via DCI, MAC-CE, or RRC, or determined and reported by UE.

In one example, event-type and report type are jointly parameterized using a joint table (e.g., Table 1). In this case, similar to examples described herein, indicators/parameters can be defined for association of UE-initiated/triggered reporting with event and report-type(s) and event-type(s).

Indicators/parameters described in this disclosure can be either in UCI part 1 or UCI part 2. Or they can be both in UCI part 1 and UCI part 2.

For indicators/parameters described in this disclosure (e.g., such as K, L, L̅, K̅, L′, K′ etc) can be fixed, pre-determined, or configured by NW, or determined by UE.

### Component 2. Reporting Configuration Framework

In one embodiment, parameter(s) or indicator(s) for UE-initiated/triggered reporting can be configured using a (information-element) framework (e.g., CSI-ReportConfig), wherein the framework includes associations between event(s) and/or event-type(s) and/or report-type(s).

In one example, the parameters/indicators can include at least one of the parameters/indicators described in one or more embodiments/examples herein.

### Framework 1. Via the CSI-ReportConfig Framework

FIG. 19 illustrates an example of CSI-ReportConfig including an enabling parameter for UE-initiated/triggered reporting 1900 according to embodiments of the present disclosure. The embodiment of the CSI-ReportConfig including an enabling parameter for UE-initiated/triggered reporting 1900 shown in FIG. 19 is for illustration only. Other embodiments of the CSI-ReportConfig including an enabling parameter for UE-initiated/triggered reporting 1900 could be used without departing from the scope of this disclosure.

In one embodiment, parameter(s)/indicator(s) for the association(s) among event(s) and/or event-type(s) and/or report-type(s) for UE-initiated/triggered reporting is/are included in the higher layer parameter CSI-ReportConfig.

In one example, an enabling parameter/indicator to indicate legacy NW-based/-controlled operation or UE-initiated/triggered reporting/operation is included in CSI-ReportConfig. For example, the parameter/indicator is a 1-bit parameter to switch either of them, where ‘1’ (or ‘enable’) enables UE-initiated/triggered reporting and ‘0’ (or ‘disable’) disables UE-initiated/triggered reporting, or enables NW-triggered (or legacy) reporting. FIG. 19 shows an illustration of CSI-ReportConfig including an enabling parameter for UE-initiated/triggered reporting.

In another example, the enabling parameter/indicator can take at three values indicating three states:
State1: NW-triggered (legacy) reporting
State2: UE-initiated/triggered reporting
State3: NW-triggered (legacy) reporting or UE-initiated/triggered reporting

When the UE is configured with State3, the triggering of the CSI report can be from the NW-side or from the UE-side. In case of collision when both NW and UE trigger the report, the UE is expected to follow the reporting according to the trigger from one of the two (e.g., NW-trigger).

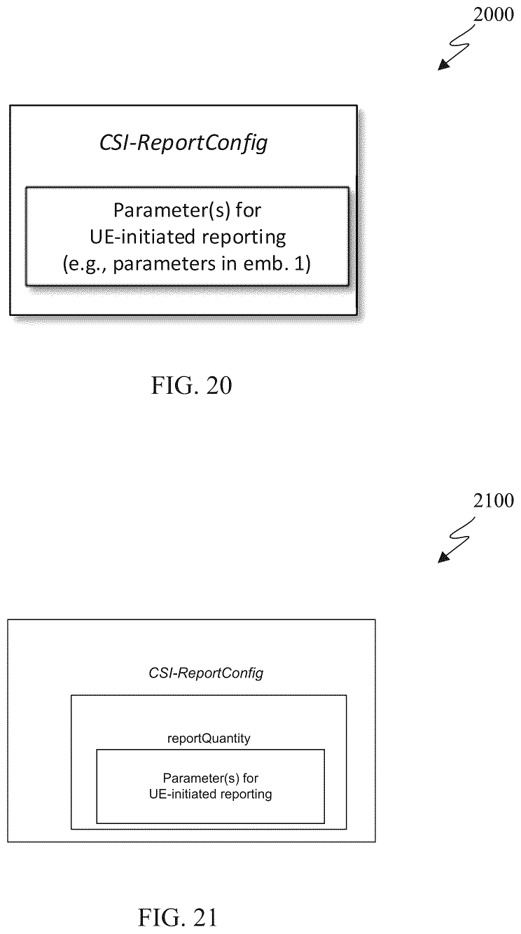

FIG. 20 illustrates an example of CSI-ReportConfig including parameters/indicators for UE-initiated/triggered reporting 2000 according to embodiments of the present disclosure. The embodiment of the CSI-ReportConfig including parameters/indicators for UE-initiated/triggered reporting 2000 shown in FIG. 20 is for illustration only. Other embodiments of the CSI-ReportConfig including parameters/indicators for UE-initiated/triggered reporting 2000 could be used without departing from the scope of this disclosure.

In one example, parameter(s)/indicator(s) for the association(s) among event(s)/event-type(s)/report-type(s) for UE-initiated/triggered reporting are included in the CSI-ReportConfig.
In one example, the parameters/indicators include at least one of the parameters for the association with events as described herein.
In one example, the parameters/indicators include at least one of the parameters for the association with event types as described herein.
In one example, the parameters/indicators include at least one of the parameters for the association between events and event-types as described herein.
In one example, the parameters/indicators include at least one of the parameters for the association with report-types.
In one example, the parameters/indicators include at least one of the parameters for the association between events and report-types.
In one example, the parameters/indicators include at least one of the parameters for the association among events and event types and report-types.

FIG. 21 illustrates an example of CSI-ReportConfig including parameters/indicators for UE-initiated/triggered reporting 2100 according to embodiments of the present disclosure. The embodiment of the CSI-ReportConfig including parameters/indicators for UE-initiated/triggered reporting 2100 shown in FIG. 21 is for illustration only. Other embodiments of the CSI-ReportConfig including parameters/indicators for UE-initiated/triggered reporting 2100 could be used without departing from the scope of this disclosure.

In one example, an existing parameter(s) of CSI-ReportConfig is reused to include parameter(s)/indicator(s) for the association(s) among event(s)/event-type(s)/report-type(s) for UE-initiated/triggered reporting.
In one example, reportQuantity includes at least one of the parameters for the association with events as described herein.
In one example, reportQuantity includes at least one of the parameters for the association with event types as described herein.
In one example, reportQuantity includes at least one of the parameters for the association between events and event-types as described herein.
In one example reportQuantity includes at least one of the parameters for the association with report-types.
In one example, reportQuantity includes at least one of the parameters for the association between events and report-types.
In one example, reportQuantity includes at least one of the parameters for the association among events and event types and report-types.

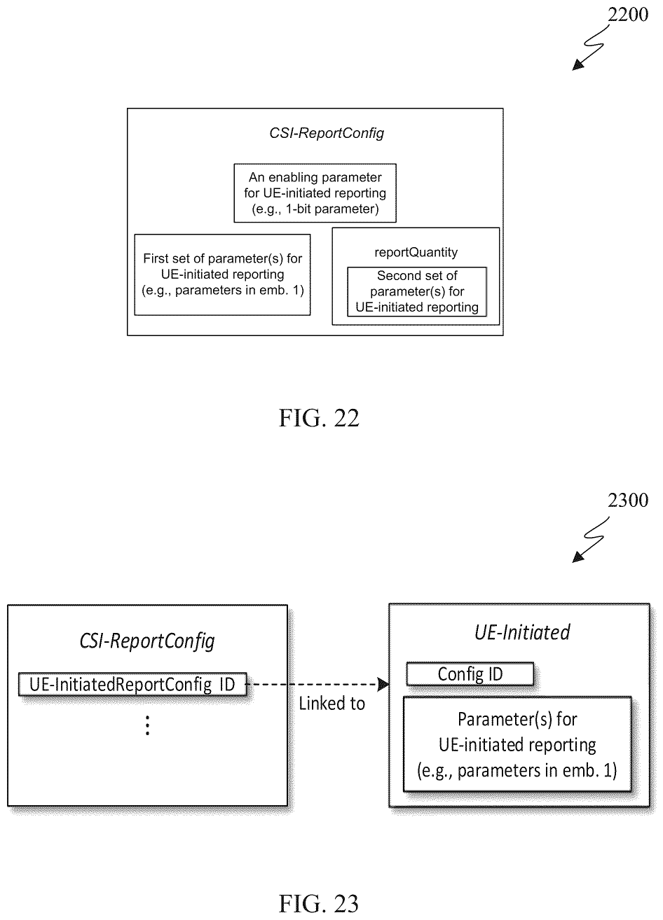

FIG. 22 illustrates an example of CSI-ReportConfig including parameters/indicators for UE-initiated/triggered reporting 2200 according to embodiments of the present disclosure. The embodiment of the CSI-ReportConfig including parameters/indicators for UE-initiated/triggered reporting 2200 shown in FIG. 22 is for illustration only. Other embodiments of the CSI-ReportConfig including parameters/indicators for UE-initiated/triggered reporting 2200 could be used without departing from the scope of this disclosure.

In one example, any combination of the above examples of CSI-ReportConfig can be an example for the framework for UE-initiated/triggered reporting. An example is CSI-ReportConfig includes an enabling parameter/indicator, a first (set of) parameter(s) for UE-initiated/triggered reporting, and/or reportQuantity including a second (set of) parameter(s) for UE-initiated/triggered reporting.

### Framework 2. Via New Information Element(s) Defined for UE-Initiated Reporting and its ID(s) in CSI-ReportConfig

FIG. 23 illustrates an example of Framework 2 2300, where a new IE(s) is defined for parameters/indicators for UE-initiated/triggered reporting and an ID(s) of the new IE is included in CSI-ReportConfig according to embodiments of the present disclosure. The embodiment of the Framework 2 2300, where a new IE(s) is defined for parameters/indicators for UE-initiated/triggered reporting and an ID(s) of the new IE is included in CSI-ReportConfig 2200 shown in FIG. 23 is for illustration only. Other embodiments of the Framework 2 2300, wherein a new IE(s) is defined for parameters/indicators for UE-initiated/triggered reporting and an ID(s) of the new IE is included in CSI-ReportConfig could be used without departing from the scope of this disclosure.

In one embodiment, a new information element(s) (IE) is defined for parameter(s)/indicator(s) for the association(s) among event(s) and/or event-type(s) and/or report-type(s) for UE-initiated/triggered reporting and an ID(s) of the new IE(s) is included in CSI-ReportConfig. For example, the new IE(s) can be called ‘UE-InitiatedEvent’, ‘UE-InitiatedEventType’, ‘UE-InitiatedReportType’, ‘UE-InitiatedConfig’, but it can be called other terminology. In another example, it can be called ‘UE-initiated’, ‘UE-triggered’, or ‘UE-initiatedConfig’, etc. We call it hereafter ‘UE-initiated’.
In one example, the new IE(s) includes at least one of the parameters for the association with events as described herein.
In one example, the new IE(s) includes at least one of the parameters for the association with event types as described herein.
In one example, the new IE(s) includes at least one of the parameters for the association between events and event-types as described herein.
In one example the new IE(s) includes at least one of the parameters for the association with report-types.

In one example, the new IE(s) includes at least one of the parameters for the association between events and report-types.
In one example, the new IE(s) includes at least one of the parameters for the association among events and event types and report-types.

The ID(s) of the new IE(s) are included in CSI-ReportConfig to link/associate a UE-initiated/triggered reporting configuration to/with CSI-ReportConfig. FIG. 21 shows an illustration of Framework 2, wherein a new IE(s) is defined for parameters/indicators for UE-initiated/triggered reporting and an ID(s) of the new IE is included in CSI-ReportConfig.

### Framework 3. (Framework 1+2). Via Parameters Included in CSI-ReportConfig+New IE(s) & ID(s) of the New IE in CSI-ReportConfig

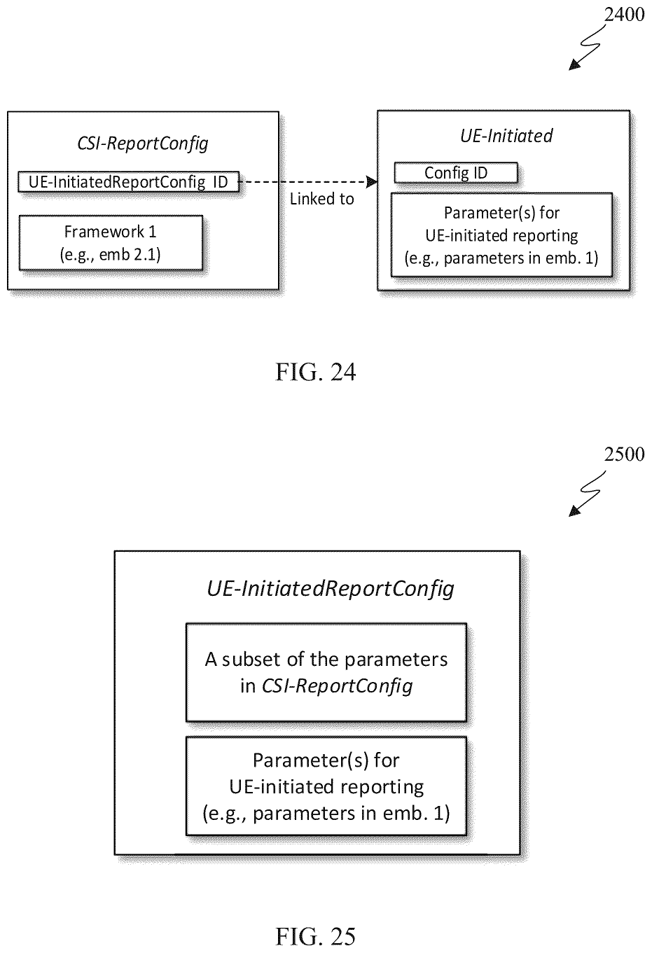

FIG. 24 illustrates an example of Framework 3 2400 according to embodiments of the present disclosure. The embodiment of the Framework 3 2400 shown in FIG. 24 is for illustration only. Other embodiments of the Framework 3 2400 could be used without departing from the scope of this disclosure.

In one embodiment, a first set of parameter(s)/indicator(s) for the association(s) among event(s) and/or event-type(s) and/or report-type(s) for UE-initiated/triggered reporting is included in the CSI-ReportConfig, and a new information element(s) (IE) is defined for a second set of parameter(s)/indicator(s) for the association(s) among event(s) and/or event-type(s) and/or report-type(s) for UE-initiated/triggered reporting and an ID(s) of the new IE(s) is included in CSI-ReportConfig.

### Framework 4. Via a New Report Config for UE-Initiated Reporting

FIG. 25 illustrates an example of Framework 4 that includes a new report configuration 2500 according to embodiments of the present disclosure. The embodiment of the Framework 4 that includes a new report configuration 2500 shown in FIG. 25 is for illustration only. Other embodiments of the Framework 4 that includes a new report configuration 2500 could be used without departing from the scope of this disclosure.

In one embodiment, a new report configuration (i.e., new IE) for UE-initiated/triggered reporting is defined and can be operated separately/independently from CSI-ReportConfig. The new IE for the report configuration can be called ‘UE-initiatedReportConfig’, ‘UE-triggeredReportConfig’, etc. For example, the new report configuration can be regarded as a smaller version of CSI-ReportConfig (i.e., it includes a subset of the parameters in CSI-ReportConfig).

In one example, the new report configuration includes a subset of the parameters in CSI-ReportConfig and new parameters (e.g., new report quantities, for example, indicators for associations among event/event-types/report-types).
In one example, the subset of parameters includes measurement reference signal configurations (e.g., NZP-CSI-RS, CSI-IM-RS).
In one example, the subset of parameters includes reportQuantity.
In one example, the subset of parameters includes reportFreqConfiguration.
In one example, the subset of parameters includes reportConfigType.
In one example, the subset of parameters includes codebookConfig.
In one example, the subset of parameters includes groupBasedBeamReporting.
In one example, the new parameters include at least one of the parameters for the association with events as described herein.
In one example, the new parameters include at least one of the parameters for the association with event types as described herein.
In one example, the new parameters include at least one of the parameters for the association between events and event-types as described herein.
In one example the new parameters include at least one of the parameters for the association with report-types.
In one example, the new parameters include at least one of the parameters for the association between events and report-types.
In one example, the new parameters include at least one of the parameters for the association among events and event types and report-types.
In one example, any combination (union) of the above examples can be an example for the new report configuration.

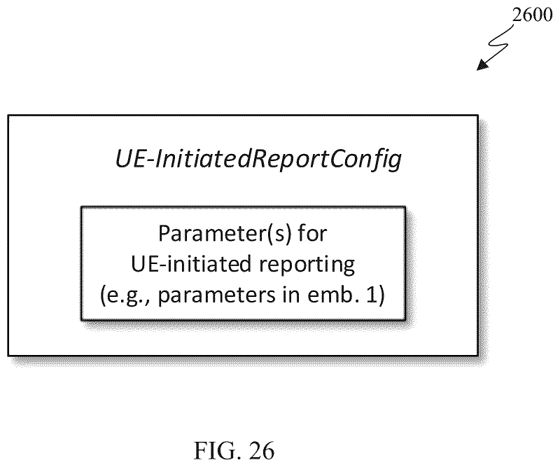

FIG. 26 illustrates another example of Framework 4 that includes a new report configuration 2600 according to embodiments of the present disclosure. The embodiment of the Framework 4 that includes a new report configuration shown 2600 in FIG. 26 is for illustration only. Other embodiments of the Framework 4 that includes a new report configuration 2600 could be used without departing from the scope of this disclosure.

In one example, the new report configuration includes new parameters only (e.g., new report quantities, for example, indicators for associations among event/event-types/report-types).
In one example, the new parameters include at least one of the parameters for the association with events.
In one example, the new parameters include at least one of the parameters for the association with event types.
In one example, the new parameters include at least one of the parameters for the association between events and event-types.
In one example the new parameters include at least one of the parameters for the association with report-types.
In one example, the new parameters include at least one of the parameters for the association between events and report-types.
In one example, the new parameters include at least one of the parameters for the association among events and event types and report-types.

In one embodiment, UE-initiated/triggered reporting described in this disclosure can be performed periodically (P), semi-persistently (SP), or aperiodically (AP). The information about the association (linking) as described above can be configured according to at least one of the following examples.
In one example, for periodic (P) UE-initiated/triggered reporting, the association (linking) can be configured by higher-layer signaling (i.e., linked to RRC parameters).
In one example, for semi-persistent (SP) UE-initiated/triggered reporting, the association (linking) can be configured by higher-layer signaling (i.e., linked to RRC parameters).
In one example, for semi-persistent (SP) UE-initiated/triggered reporting, the association (linking) can be configured via MAC-CE signaling.
In one example, for semi-persistent (SP) UE-initiated/triggered reporting, the association (linking) can be configured by higher-layer signaling (i.e., RRC parameters) and MAC-CE signaling.
In one example, for aperiodic (AP) UE-initiated/triggered reporting, the association (linking) can be configured by higher-layer signaling (i.e., RRC parameters).
In one example, for aperiodic (AP) UE-initiated/triggered reporting, the association (linking) can be configured via MAC-CE signaling.
In one example, for aperiodic (AP) UE-initiated/triggered reporting, the association (linking) can be configured via DCI signaling.
In one example, for aperiodic (AP) UE-initiated/triggered reporting, the association (linking) can be configured by higher-layer signaling (i.e., RRC parameters) and MAC-CE signaling.
In one example, for aperiodic (AP) UE-initiated/triggered reporting, the association (linking) can be configured via higher-layer signaling (i.e., RRC parameters) and DCI signaling.
In one example, for aperiodic (AP) UE-initiated/triggered reporting, the association (linking) can be configured via MAC-CE signaling and DCI signaling.
In one example, for aperiodic (AP) UE-initiated/triggered reporting, the association (linking) can be configured via higher-layer signaling (i.e., RRC parameters), MAC-CE signaling, and DCI signaling.

In one example, DCI triggering AP CSI reporting can indicate whether it is UE-initiated or not (normal/legacy NW-triggered report).

In one embodiment, the UE-initiated/triggered reporting described in this disclosure can only be aperiodic (AP).

In one embodiment, the UE-initiated/triggered reporting described in this disclosure can only be aperiodic (AP) or semi-persistent (SP).

### Component 3. Triggering Framework Using Reporting Configuration

In one embodiment, UE-initiated/triggered reporting can be performed according to at least one of the following examples.
Example A (Legacy framework (i.e., NW-controlled approach)): CSI-ReportConfig including measurement RS ID(s) and reportQuantity can be configured to a UE. When the NW (or target entity) detects a need for a report such as CSI reporting, the NW can perform triggering for associated reporting and transmit the RS(s) associated with the measurement RS ID(s). The UE measures the transmitted RS and performs the associated reporting.
Example B1 (UE-initiated approach): CSI-ReportConfig including measurement RS ID(s) and reportQuantity can be configured to a UE. When the UE detects a need for a report such as CSI reporting, the UE can perform triggering for associated reporting. Then, the NW (a target entity) transmits the RS(s) associated with the measurement RS ID(s), and the UE measures the transmitted RS and performs the associated reporting.
Example A+B1 (triggering from NW or UE): CSI-ReportConfig including measurement RS ID(s) and reportQuantity can be configured to a UE. When UE and/or NW (a target entity) detects a need for a report such as CSI reporting, the entity(-ies) detecting the need can perform triggering for associated reporting. In one example, a UE can perform triggering. In another example, a NW can perform triggering. In another example, both UE and NW can perform triggering. Then, the NW transmits the RS(s) associated with the measurement RS ID(s), and the UE measures the transmitted RS and performs the associated reporting.
   In one example, when both UE and NW performs triggering under a time window (i.e., when collision happens), the UE/NW follows reporting associated with the latest triggered one (in terms of time).
   In one example, when both UE and NW performs triggering under a time window (i.e., when collision happens), the UE/NW follows reporting associated with the triggering from the NW.
   In one example, when both UE and NW performs triggering under a time window (i.e., when collision happens), the UE/NW follows reporting associated with the triggering from UE.
   In one example, when both UE and NW performs triggering under a time window (i.e., when collision happens), the both of the corresponding reporting are not performed and the NW decides one of them and indicates it to the UE.
   In one example, when both UE and NW performs triggering under a time window (i.e., when collision happens), the both of the corresponding reporting are not performed and the UE decides one of them and indicates it to the NW.
Example B2 (UE-initiated, Trigger includes reportQuantity): CSI-ReportConfig including measurement RS ID(s) but not reportQuantity (e.g., absent) can be configured to a UE. Or, CSI-ReportConfig including measurement RS ID(s) and reportQuantity set to ‘none’ can be configured to a UE. When the UE detects a need for a report such as CSI reporting, the UE can perform triggering for associated reporting. When the UE performs triggering, the UE also indicates reportQuantity. In one example, the UCI triggering the report also includes reportQuantity. Then, the NW transmits the RS(s) associated with the measurement RS ID(s), and the UE measures the transmitted RS and performs the associated reporting.
Example B3 (UE-initiated, Trigger includes some information about reportQuantity): CSI-ReportConfig including measurement RS ID(s) and reportQuantity can be configured to a UE. When the UE detects a need for a report such as CSI reporting, the UE can perform triggering for associated reporting. When the UE performs triggering, the UE also indicates information about reportQuantity. In one example, the UCI triggering the report also includes information about reportQuantity. Then, the NW transmits the RS(s) associated with the measurement RS ID(s), and the UE measures the transmitted RS and performs the associated reporting.
Example B4 (UE-initiated, Trigger includes ReportConfig): When the UE detects a need for a report such as CSI reporting, the UE can perform triggering for associated reporting. When the UE performs triggering, the UE also indicates a configuration called ReportConfig, where the ReportConfig includes measurement RS ID(s) and reportQuantity. In one example, the UCI triggering the report also includes measurement RS ID(s) and reportQuantity. Then, the NW transmits the RS(s) associated with the measurement RS ID(s), and the UE measures the transmitted RS and performs the associated reporting.

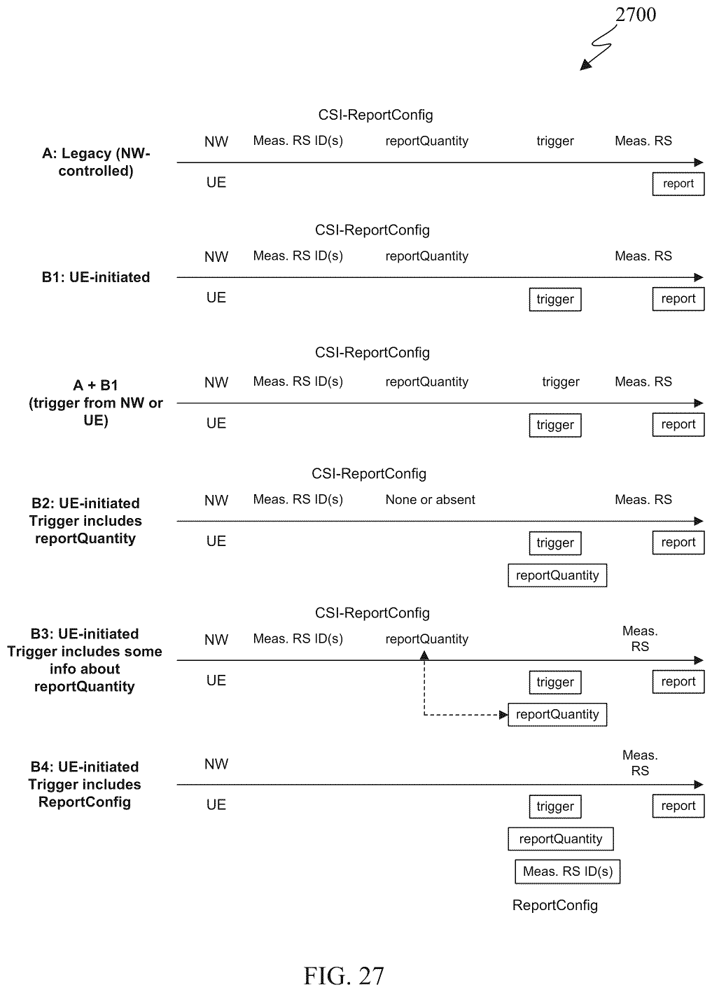

FIG. 27 illustrates an example of UE-initiated/UE-triggered reporting 2700 according to embodiments of the present disclosure. The embodiment of the UE-initiated/UE-triggered reporting 2700 shown in FIG. 27 is for illustration only. Other embodiments of the UE-initiated/UE-triggered reporting 2700 could be used without departing from the scope of this disclosure.

In one example, for any subset of the examples described above, at least one of the examples in the subset can be configured by NW. For example, for all of the examples described above, one approach can be configured by NW.

In one embodiment, each example described herein can be linked to one or more other embodiments described herein.
In one example, CSI-ReportConfig described in an example of an embodiment herein can be used/applied for (linked to) CSI-ReportConfig in an example of another embodiment described herein.
In one example, UE-Initiated described in an example of an embodiment herein can be used/applied for (linked to) CSI-ReportConfig in an example of another embodiment described herein.
In one example, reportQuantity described herein includes at least one of the parameters/indicators described in another embodiment described herein.
In one example, UE-initiatedReportConfig described in an example of an embodiment described herein can be used/applied for (linked to) ReportConfig described in an example of another embodiment described herein.

### Component 4. Two-Stage UCI Framework for UE-Initiated/UE-Triggered Reporting

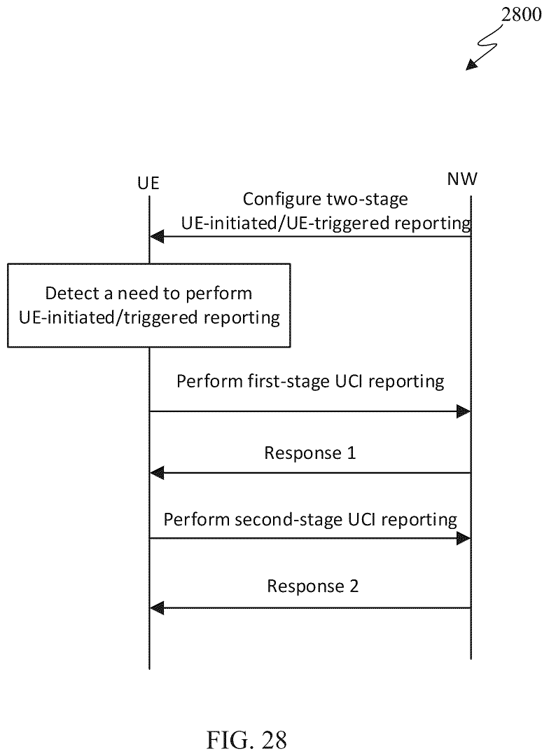

FIG. 28 illustrates a flow diagram 2800 of an example two-stage UCI framework for UE-initiated/UE-triggered reporting according to embodiments of the present disclosure. The embodiment of the flow diagram 2800 of an example two-stage UCI framework for UE-initiated/UE-triggered reporting shown in FIG. 28 is for illustration only. Other embodiments of the flow diagram 2800 of an example two-stage UCI framework for UE-initiated/UE-triggered reporting could be used without departing from the scope of this disclosure.

In one embodiment, a UE is configured with UE-initiated/UE-triggered reporting via a two-stage UCI framework, wherein the first-stage UCI contains information X₁ and the second-stage UCI contains information X₂. The first-stage/second-stage UCI can be transmitted using an independent (or separate/disjoint) set of time/frequency resources for UL transmissions.

In one embodiment, a configuration for UE-initiated/UE-triggered reporting via the two-stage UCI framework includes UL resource allocation for the first-stage UCI reporting. The UL resource allocation can be either RACH-based (e.g., shared resources by a set of UEs) or configured-based. Once a UE detects a need (either the case of event-based triggering or non-event-based triggering) to perform UE-initiated/UE-triggered reporting, the UE performs first-stage UCI reporting using the allocated UL resource(s). Once a target entity (e.g., NW/gNB) receives the first-stage UCI reporting, the target entity sends a first response. The UE then performs second-stage UCI reporting based on the information contained in the first response. Once the target entity receives the second-stage UCI reporting, the target entity sends a second response. The second response includes ACK/NACK response.

In one example, the information X₁ in the first-stage UCI includes at least one of the following information elements (parameters): event-type/report-type indicator(s), pre-notification/trigger message(s), parameters to indicate associated events(/event-types), a subset of content of UE-initiated/triggered reporting, UL resource allocation request for the second stage.

In one example, the information X₂ in the second-stage UCI includes at least one of the following information elements (parameters): event-type/report-type indicator(s), pre-notification/trigger message(s), parameters to indicate associated events(/event-types), a subset or all of content of UE-initiated/triggered reporting.

In one embodiment, a configuration for UE-initiated/UE-triggered reporting via the two-stage UCI framework includes UL resource allocations for the first-stage UCI reporting and the second-stage UCI reporting. The UL resource allocations can be either RACH-based (e.g., shared resources by a set of UEs) or configured-based. Once a UE detects a need (either the case of event-based triggering or non-event-based triggering) to perform UE-initiated/UE-triggered reporting, the UE performs first-stage UCI reporting using allocated UL resources. In one example, the first-stage UCI contains indication of UL resources for the second-stage UCI transmission. In this case, the UE performs second-stage UCI reporting using the indicated UL resources. In another example, the first-stage UCI does not contain any indication of UL resources for the second-stage UCI transmission. In this case, the UE uses UL resource allocation configured by a target entity (or NW/gNB) for the second-stage UCI reporting. Once the target entity receives the second-stage UCI reporting, the target entity sends a response. The response can include ACK/NACK.

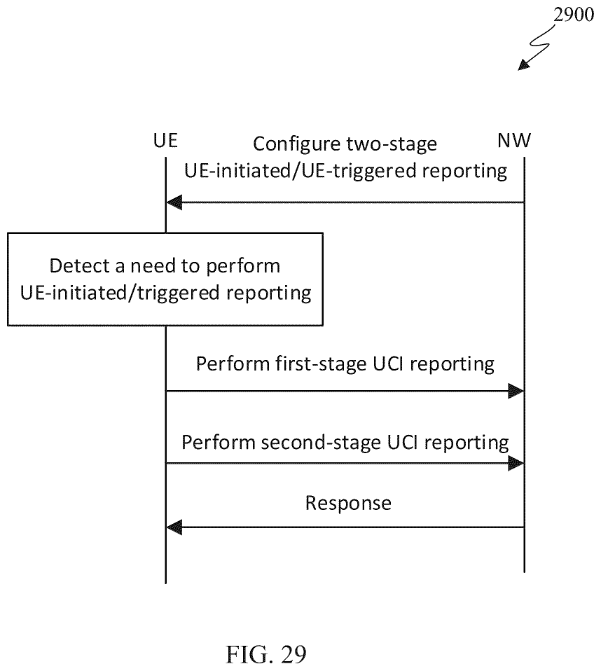

FIG. 29 illustrates a flow diagram 2900 of another example two-stage UCI framework for UE-initiated/UE-triggered reporting according to embodiments of the present disclosure. The embodiment of the flow diagram 2900 of an example two-stage UCI framework for UE-initiated/UE-triggered reporting shown in FIG. 29 is for illustration only. Other embodiments of the flow diagram 2900 of an example two-stage UCI framework for UE-initiated/UE-triggered reporting could be used without departing from the scope of this disclosure.

In one example, information X₁ in the first-stage UCI contains at least one of the following information elements (parameters): event-type/report-type indicator(s), pre-notification/trigger message(s), parameters to indicate associated events(/event-types, indication of UL resource allocation for the second-stage UCI.

In one example, information X₂ in the second-stage UCI contains at least one of the following information elements (parameters): event-type/report-type indicator(s), pre-notification/trigger message(s), parameters to indicate associated events(/event-types), a subset or all of content of UE-initiated/triggered reporting.

In one embodiment, either (or both) information X₁ in the first-stage UCI or (and) information X₂ in the second-stage UCI can be divided into two-part and reported in a two-part UCI manner.

In one example, information X₁ in the first-stage UCI can be divided into two-part and reported in a two-part UCI manner.

In one example, information X₂ in the second-stage UCI can be divided into two-part and reported in a two-part UCI manner.

In one example, both information X₁ in the first-stage UCI and X₂ in the second-stage UCI can be divided into two-part, respectively, and reported in a two-part UCI manner.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to receive information about (i) L events and (ii) K event types, where L≥1 and K≥1, wherein at least one of the L events is associated with at least one of the K event types; and
a processor operably coupled to the transceiver, the processor configured to determine whether to transmit a report based on at least one of L′ events from the L events;
wherein the transceiver is further configured to transmit, based on the determination, the report that includes an indicator indicating the L′ events.

2. The UE of claim 1, wherein, when K=L, each of the L events is associated with a corresponding event type.

3. The UE of claim 1, wherein the indicator corresponds to one of:
(i) a L-bit bitmap indicator,
(ii) a ┌log₂ L┐-bit indicator, and
(iii) a ┌log₂ L┐-bit indicator and a
$$⌈ {log}_{2} ( \begin{matrix}L \\ {L}^{′}\end{matrix} ) ⌉ ‐ bit indicator .$$

4. The UE of claim 3, wherein, when the indicator corresponds to (iii), the ┌log₂ L┐-bit indicator is in an uplink control information (UCI) part 1 of the report and the
$$⌈ {log}_{2} ( \begin{matrix}L \\ {L}^{′}\end{matrix} ) ⌉ ‐ bit indicator$$
is in an UCI part 2 of the report.

5. The UE of claim 1, wherein Lₖ events are associated with a corresponding event type, where L=Σ_{K=1}^{K}Lₖ.

6. The UE of claim 5, wherein the indicator corresponds to one of:
(i) a L-bit bitmap indicator,
(ii) a K-bit bitmap indicator,
(iii) a ┌log₂ K┐-bit indicator and a
$$⌈ {log}_{2} ( \begin{matrix}K \\ {K}^{′}\end{matrix} ) ⌉ ‐ bit indicator ,$$
where K′≤K is a number of event types, and
(iv) a ┌log₂ K┐-bit indicator and a event types, and
(v) a K-bit bitmap indicator and a ΣLₖ-bit bitmap indicator for a subset of K event types.

7. The UE of claim 6, wherein:
when the indicator corresponds to (iv), the ┌log₂ K┐-bit indicator is in an uplink control information (UCI) part 1 of the report and the
$$⌈ {log}_{2} ( \begin{matrix}K \\ {K}^{′}\end{matrix} ) ⌉ ‐ bit indicator$$
is in an UCI part 2 of the report, or
when the indicator corresponds to (v), the K-bit bitmap indicator is in the UCI part 1 of the report and the ΣLₖ-bit bitmap indicator is in the UCI part 2 of the report.

8. The UE of claim 1, wherein the processor is further configured to:
determine, based on the L′ events, a report quantity, where the report quantity is associated with the L′ events, and
include the report quantity in the report.

9. A base station (BS), comprising:
a processor; and
a transceiver operably coupled to the processor, the transceiver configured to:
transmit information about (i) L events and (ii) K event types, where L≥1 and K≥1, wherein at least one of the L events is associated with at least one of the K event types; and
receive a report that includes an indicator indicating at least one of L′ events from the L events.

10. The BS of claim 9, wherein, when K=L, each of the L events is associated with a corresponding event type.

11. The BS of claim 9, wherein the indicator corresponds to one of:
(i) a L-bit bitmap indicator,
(ii) a ┌log₂ L┐-bit indicator, and
(iii) a ┌log₂ L┐-bit indicator and a
$$⌈ {log}_{2} ( \begin{matrix}L \\ {L}^{′}\end{matrix} ) ⌉ ‐ bit indicator .$$

12. The BS of claim 11, wherein, when the indicator corresponds to (iii), the ┌log₂ L┐-bit indicator is in an uplink control information (UCI) part 1 of the report and the
$$⌈ {log}_{2} ( \begin{matrix}L \\ {L}^{′}\end{matrix} ) ⌉ ‐ bit indicator$$
is in an UCI part 2 of the report.

13. The BS of claim 9, wherein Lₖ events are associated with a corresponding event type, where L=Σ_{K=1}^{K}Lₖ.

14. The BS of claim 13, wherein the indicator corresponds to one of:
(i) a L-bit bitmap indicator,
(ii) a K-bit bitmap indicator,
(iii) a ┌log₂ K┐-bit indicator,
(iv) a ┌log₂ K┐-bit indicator and a
$$⌈ {log}_{2} ( \begin{matrix}K \\ {K}^{′}\end{matrix} ) ⌉ ‐ bit indicator ,$$
where K′≤K is a number of event types, and
(v) a K-bit bitmap indicator and a ΣLₖ-bit bitmap indicator for a subset of K event types.

15. The BS of claim 14, wherein:
when the indicator corresponds to (iv), the ┌log₂ K┐-bit indicator is in an uplink control information (UCI) part 1 of the report and the
$$⌈ {log}_{2} ( \begin{matrix}K \\ {K}^{′}\end{matrix} ) ⌉ ‐ bit indicator$$
is in an UCI part 2 of the report, or
when the indicator corresponds to (v), the K-bit bitmap indicator is in the UCI part 1 of the report and the ΣLₖ-bit bitmap indicator is in the UCI part 2 of the report.

16. The BS of claim 9, wherein report includes a report quantity that is based on the L′ events.

17. A method performed by a user equipment (UE), the method comprising:
receiving information about (i) L events and (ii) K event types, where L≥1 and K≥1, wherein at least one of the L events is associated with at least one of the K event types;
determining whether to transmit a report based on at least one of L′ events from the L events; and
transmitting, based on the determination, the report that includes an indicator indicating the L′ events.

18. The method of claim 17, wherein, when K=L, each of the L events is associated with a corresponding event type.

19. The method of claim 17, wherein the indicator corresponds to one of:
(i) a L-bit bitmap indicator,
(ii) a ┌log₂ L┐-bit indicator, and
(iii) a ┌log₂ L┐-bit indicator and a
$$⌈ {log}_{2} ( \begin{matrix}L \\ {L}^{′}\end{matrix} ) ⌉ ‐ bit indicator .$$

20. The method of claim 19, wherein, when the indicator corresponds to (iii), the ┌log₂ L┐-bit indicator is in an uplink control information (UCI) part 1 of the report and the
$$⌈ {log}_{2} ( \begin{matrix}L \\ {L}^{′}\end{matrix} ) ⌉ ‐ bit indicator$$
is in an UCI part 2 of the report.
